(19) United States
(12) Patent Application Publication
(10) Pub. No.: US 2016/0026272 A1
(43) Pub. Date: Jan. 28, 2016

(54) METHOD FOR DISPLAYING SCREEN IN ELECTRONIC DEVICE, AND ELECTRONIC DEVICE THEREOF

(71) Applicant: Samsung Electronics Co., Ltd., Gyeonggi-do (KR)

(72) Inventors: Hye-Ju PARK, Seoul (KR); Sang-Hyuk KOH, Jeju-do (KR); Yeon-Hwa OH, Seoul (KR); Si-Hak JANG, Gyeonggi-do (KR)

(73) Assignee: Samsung Electronics Co., Ltd.

(21) Appl. No.: 14/806,287

(22) Filed: Jul. 22, 2015

(30) Foreign Application Priority Data
Jul. 22, 2014 (KR) 10-2014-0092395

(51) Int. Cl. G06F 3/0354; G06F 3/0488; G06F 3/0481; G06F 3/041

(52) U.S. Cl. CPC G06F 3/03545; G06F 3/0412; G06F 3/04886; G06F 3/04817; G06F 2203/04101; G06F 2203/04104; G06F 2203/04803; G06F 2203/04807; G06F 2203/04808

(57) ABSTRACT

A method and an apparatus are provided for displaying a screen in an electronic device. The method includes displaying, in a split way, a first screen for displaying information corresponding to one or more objects and a second screen for displaying the objects to assist the first screen, detecting a pen interaction on the second screen, identifying an object in a position corresponding to the pen interaction, and displaying information corresponding to the identified object and the pen interaction on the first screen.

### PRIORITY

This application claims priority under 35 U.S.C. §119(a) to a Korean Patent Application filed in the Korean Intellectual Property Office on Jul. 22, 2014, and assigned Serial No. 10-2014-0092395, the entire disclosure of which is incorporated herein by reference.

### BACKGROUND

1. Field of Invention

The present invention relates generally to a method for displaying screens in an electronic device, and more specifically to displaying a first and second screen in a split fashion in an electronic device.

2. Description of Related Art

In recent years, due to the rapid development of electronic technology, functions of electronic devices, such as tablet Personal Computers (PCs) and smartphones, have been diversified, and the electronic devices are capable of storing dozens of different applications. Menu keys or shortcut keys for executing the applications may be displayed on a touch screen of an electronic device, in the form of an icon. A user may execute a desired application on the electronic device by touching any one of the icons displayed on the touch screen. In addition to the menu keys and shortcut keys, a variety of objects such as widgets, photos and documents may be displayed on the touch screen of the electronic device.

In the typical screen display technology for electronic devices, a user of an electronic device may interact with a touch screen of the electronic device in a contact and/or noncontact based manner, to display a related object and its information on a screen displayed on the touch screen.

In the conventional screen display technology for electronic devices, an electronic device displays only one screen on its touch screen, so there is a limit in utilizing the screen in a variety of ways. Conventionally, there is no way to provide screen display methods for displaying, for example, information related to icons on a screen while displaying the icons, or specific information about icons on a preview screen while displaying the icons.

In addition, conventionally, a method of utilizing screens by means of an input means such as an electronic pen (hereinafter referred to as a ‘pen’ for simplicity) has not been considered in an electronic device that displays first and second screens in a split manner.

### SUMMARY

The present invention has been made to address at least the above-described problems and/or disadvantages, and to provide at least the advantages described below.

Accordingly, an aspect of the present invention is to provide a method for displaying first and second screens, in a split manner, in an electronic device, to make it possible to efficiently use the screen of the electronic device, and to enable a user to easily utilize objects in the electronic device using a pen, and an electronic device thereof.

In accordance with an aspect of the present invention, there is provided a method for displaying a screen in an electronic device. The method includes displaying, in a split way, a first screen for displaying information corresponding to one or more objects and a second screen for displaying the objects to assist the first screen; detecting a pen interaction on the second screen, identifying an object in a position corresponding to the pen interaction; and displaying information corresponding to the identified object and the pen interaction on the first screen.

In accordance with another aspect of the present invention, there is provided an electronic device that includes a touch screen and a processor. The processor is configured to display, in a split way, a first screen for displaying information corresponding to one or more objects and a second screen for displaying the objects to assist the first screen, detect a pen interaction on the second screen, identify an object in a position corresponding to the pen interaction, and display information corresponding to the identified object and the pen interaction on the first screen n.

Other aspects, advantages, and salient features of the invention will become apparent to those skilled in the art from the following detailed description, which, taken in conjunction with the annexed drawings, discloses various embodiments of the present invention.

### BRIEF DESCRIPTION OF THE DRAWINGS

The above and other aspects, features and advantages of certain embodiments the present invention will be more apparent from the following description taken in conjunction with the accompanying drawings, in which:

FIG. 1 is a block diagram of an electronic device, according to an embodiment of the present invention;

FIG. 2 illustrates a screen that is split into a first and a second screen, according to an embodiment of the present invention;

FIGS. 3A to 3C illustrate examples of pen interactions, according to an embodiment of the present invention;

FIG. 4 is a flowchart illustrating a method of displaying a first screen and a second screen in an electronic, device according to various embodiments of the present invention;

FIGS. 5A to 5D illustrate examples of screens of an electronic device in response to pen interactions, according to various embodiments of the present invention;

FIGS. 6A to 6C illustrate additional examples of screens of an electronic device in response to pen interactions, according to various embodiments of the present invention;

FIG. 7 is a flowchart illustrating a method of displaying screens in an electronic device, according to a first embodiment of the present invention;

FIGS. 8A to 8E illustrate examples of screens of an electronic device, according to the first embodiment of the present invention;

FIG. 9 is a flowchart illustrating a method of displaying screens in an electronic device, according to a second embodiment of the present invention;

FIGS. 10A and 10B illustrate examples of screens of an electronic device, according to the second embodiment of the present invention;

FIG. 11 is a flowchart illustrating a method of displaying screens in an electronic device, according to a third embodiment of the present invention;

FIGS. 12A to 12C illustrate examples of screens of an electronic device, according to the third embodiment of the present invention;

FIG. 13 is a flowchart illustrating a method of displaying screens in an electronic device, according to a fourth embodiment of the present invention;

FIG. 14 illustrates an example of screens of an electronic device, according to the fourth embodiment of the present invention;

FIG. 15 is a flowchart illustrating a method of displaying screens in an electronic device, according to a fifth embodiment of the present invention;

FIGS. 16A and 16B illustrate examples of screens of an electronic device, according to the fifth embodiment of the present invention;

FIG. 17 is a flowchart illustrating a method of displaying screens in an electronic device, according to a sixth embodiment of the present invention;

FIGS. 18A to 18C illustrate examples of screens of an electronic device, according to the sixth embodiment of the present invention;

FIG. 19 is a flowchart illustrating a method of displaying screens in an electronic device, according to a seventh embodiment of the present invention;

FIGS. 20A to 20C illustrate examples of screens of an electronic device, according to the seventh embodiment of the present invention; and

FIG. 21 is a block diagram of an electronic device, according to various embodiments of the present invention.

Throughout the drawings, like reference numerals will be understood to refer to like parts, components, and structures.

### DETAILED DESCRIPTION OF EMBODIMENTS OF THE PRESENT INVENTION

The following description with reference to the accompanying drawings is provided to assist in a comprehensive understanding of the various embodiments of the present invention as defined by the claims and their equivalents. However, the embodiments described herein are to be regarded as merely exemplary. Accordingly, those of ordinary skilled in the art will recognize that various changes and modifications of the embodiments described herein can be made without departing from the scope and spirit of the present invention. In addition, descriptions of well-known functions and constructions may be omitted for clarity and conciseness.

The terms and words used in the following description and claims are not limited to their bibliographical meanings, but, are merely used by the inventor to enable a clear and consistent understanding of the disclosure. Accordingly, it should be apparent to those skilled in the art that the following description of exemplary embodiments of the present invention is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

An electronic device according to various embodiments of the present disclosure may be a device with a communication function. For example, the electronic device may include at least one of a smart phone, a tablet PC, a mobile phone, a video phone, an e-book reader, a desktop PC, a laptop PC, a netbook computer, a Personal Digital Assistant (PDA), a Portable Multimedia Player (PMP), an MP3 player, a mobile medical device, a camera, and a wearable device (e.g., a Head-Mounted-Device (HMD), such as electronic eyeglasses, electronic clothing, an electronic bracelet, an electronic necklace, an electronic accessory (or appcessory), an electronic tattoo, or a smart watch).

In some embodiments of the present invention, the electronic device may be a smart home appliance with a communication function. The smart home appliance may include, for example, at least one of a Television (TV), a Digital Video Disk (DVD) player, an audio device, a refrigerator, an air conditioner, a vacuum cleaner, an oven, a microwave oven, a washer, an air purifier, a set-top box, a TV box (e.g., Samsung HomeSync™, Apple TV™, or Google TV™), game consoles, an electronic dictionary, an electronic key, a camcorder, and an electronic photo frame.

In some embodiments of the present invention, the electronic device may include at least one of various medical devices (e.g., a Magnetic Resonance Angiography (MRA) device, a Magnetic Resonance Imaging (MRI) device, Computed Tomography (CT) device, a medical camcorder, an ultrasonic device, etc.), a navigation device, a Global Positioning System (GPS) receiver, an Event Data Recorder (EDR), a Flight Data Recorder (FDR), a car infotainment device, a marine electronic equipment (e.g., a marine navigation system, a gyro compass, and the like), avionics, security equipment, a car head unit, an industrial or domestic robot, an Automatic Teller's Machine (ATM) for banks, Point of Sales (POS) system for shops, and the like.

In some embodiments of the present invention, the electronic device may include at least one of a part of a furniture or building/structure with a communication function, an electronic board, an electronic signature receiving device, a projector, and various measurement devices (e.g., meters for water, electricity, gas, radio waves or the like).

The electronic device, according to various embodiments of the present invention, may be any one or a combination of the above-described various devices. Alternatively, the electronic device according to various embodiments of the present invention may be a flexible device.

It will be apparent to those of ordinary skill in the art that the electronic device according to various embodiments of the present disclosure is not limited to the above-described devices.

The term ‘user’ as used herein may refer to the person who uses the electronic device or to the device (e.g., an artificial intelligence electronic device) that uses the electronic device.

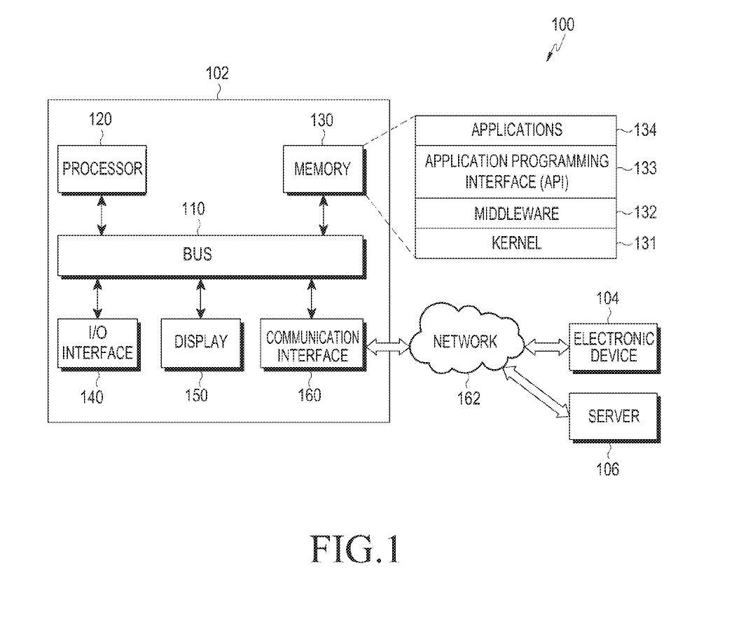

FIG. 1 is a block diagram of an electronic device, according to an embodiment of the present invention.

Referring to FIG. 1, an electronic device 102 includes a bus 110, a processor 120, a memory 130, an Input/Output (I/O) interface 140, a display 150, and a communication interface 160.

The bus 110 is a circuit that connects the components of the electronic device 102 to each other, and transmits communication signals (e.g., control messages) between the components.

The processor 120 receives a command from other components (e.g., the memory 130, the I/O interface 140, the display 150, and the communication interface 160) via the bus 110, decrypts the received command, and performs operation or data processing in response to the decrypted command.

In accordance with an embodiment of the present invention, the processor 120 is configured to display, in a split fashion, a first screen and a second screen on the display 150. The first screen is for displaying information corresponding to one or more objects and the second screen is for displaying the objects. The processor 120 is further configured to detect a pen interaction on the second screen of the display 150, to identify an object in a position corresponding to the pen interaction, and to display information corresponding to the identified object and the pen interaction on the first screen of the display 150 (or the touch screen). The first screen and the second screen are non-coplanar. Additionally, the first screen and the second screen can be executed in a single touch screen.

In accordance with an embodiment of the present invention, the object may include a variety of things for executing specific functions of the electronic device 102, such as an icon, a widget, a notification indicator, indicating an event that has occurred in the electronic device 102, specified schedule information, content (e.g., photos, videos and the like), an edit item for editing of the first screen, an edit item for editing of content displayed on the first screen, and metadata information of content displayed on the first screen.

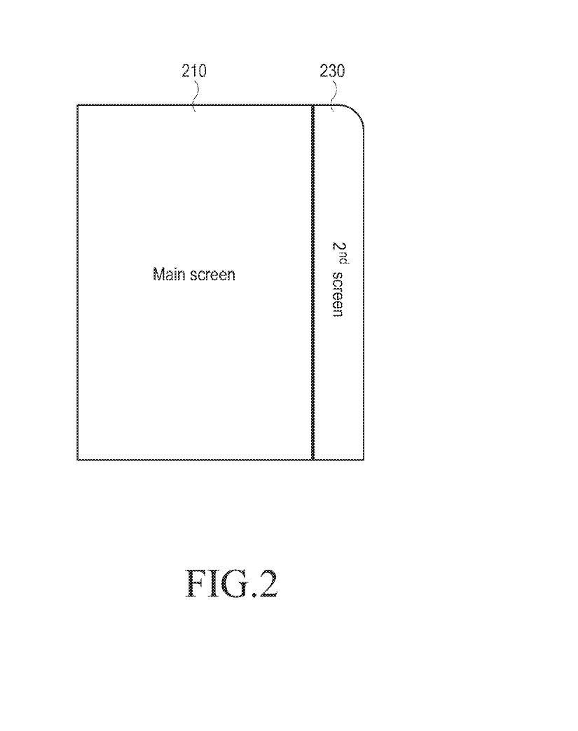

FIG. 2 illustrates a screen that is split into a first and a second screen, according to an embodiment of the present invention.

Referring to FIG. 2, the first screen is provided in the form of a main screen 210 and displays, information about the icons, widgets, and the like executed by the user, and/or content of photos, videos, and the like. The second screen is provided in the form of a second screen 230 and is separate from the first screen 210. The second screen 230 displays the icons, widgets, and the like executed by the user, and/or the content of photos, videos and the like, in order to show information related to the icons, widgets and the like executed by the user, and/or the content of photos, videos, etc., in a supplemental manner.

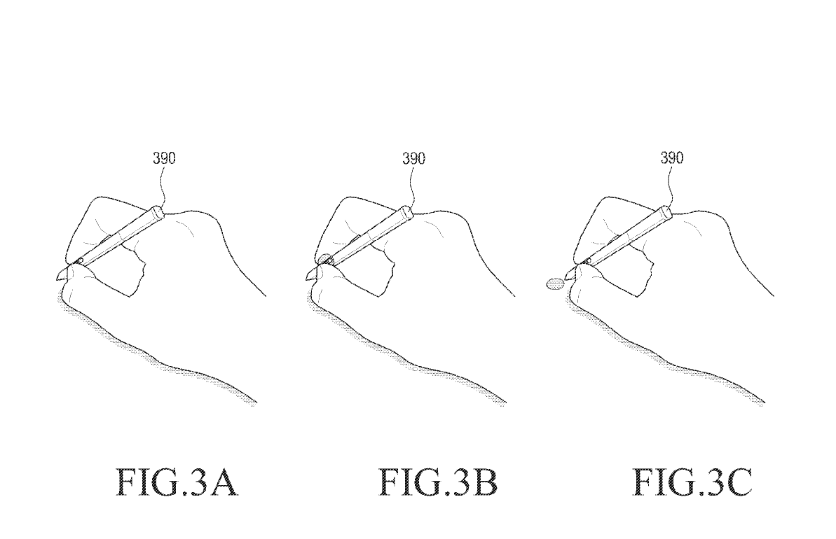

FIGS. 3A to 3C illustrate examples of pen interactions, according to an embodiment of the present invention.

Referring to FIGS. 3A to 3C, in accordance with an embodiment of the present invention, the term ‘pen interaction’, as used herein, refers to an action of controlling or manipulating the electronic device 102 using a pen 390. A pen interaction may include a tap, i.e., a gesture of a short and light tapping of the screen with the pen 390, as shown in FIG. 3A; an air button input, i.e., a signal input to the electronic device 102 in response to the push of a button mounted on the pen 390, as shown in FIG. 3B; and a hovering input by the pen 390, i.e. an input provided to the electronic device in response to the pen 390 hovering above the electronic device, as shown in FIG. 3C.

Referring back to FIG. 1, the memory 130 stores the command or data that is received from the processor 120 or other components of the electronic device 102 (i.e., the I/O interface 140, the display 150, the communication interface 160), or generated by the processor 120 or other components of the electronic device 102. The memory 130 includes programming modules 100, such as a kernel 131, a middleware 132, an Application Programming Interface (API) 133, and applications 134. Each of the programming modules may be configured as software, firmware, hardware, or a combination of at least two of them.

The kernel 131 controls or manages the system resources (e.g., the bus 110, the processor 120, and the memory 130) used to execute an operation or function implemented in the other programming modules (i.e., the middleware 132, the API 133, and the applications 134). The kernel 131 provides an interface via which the middleware 132, the API 133, and the applications 134 can access and control or manage the individual components of the electronic device 102.

The middleware 132 acts as an intermediary so that the API 133 or the applications 134 may communicate with the kernel 131 to exchange data. As for task requests received from the applications 134, the middleware 132 may manage (e.g., scheduling or load balancing) the task requests using a method of, for example, assigning a priority to at least one of the applications 134 for using the system resources (i.e., the bus 110, the processor 120, and the memory 130 or) of the electronic device 102.

The API 133, which is an interface through which the applications 134 can control the function provided by the kernel 131 or the middleware 132, includes at least one interface or function (e.g., a command) for file control, window control, image processing or character control, for example.

In accordance with various embodiments of the present invention, the applications 134 may include a Short Message Service (SMS)/Multimedia Messaging Service (MMS) application, an E-mail application, a calendar application, an alarm application, a healthcare application (e.g., an application for measuring the quantity of exercise or blood glucose levels), an environmental information application (e.g., an application for providing pressure, humidity, or temperature information), or the like. Additionally or alternatively, the applications 134 may be applications related to information exchange between the electronic device 102 and an external device (e.g., electronic device 104 or server 106. The applications related to information exchange include, for example, a notification relay application for sending specific information to the external electronic device, or a device management application for managing the external electronic device.

For example, the notification relay application includes a function of sending notification information generated by other applications (e.g., the SMS/MMS application, E-mail application, healthcare application, environmental information application, or the like) in the electronic device 102 to the external device (e.g., the electronic device 104 or server 106. Additionally or alternatively, the notification relay application may receive notification information from the external device (e.g., the electronic device 104 or server 106), and provide the received notification information to the user.

The device management application manages functions for at least a part of the external device communicating with the electronic device 102 (e.g., the enablement or disenablement of the external device or some components thereof, or the adjustment of the brightness or resolution of the display), or may manage (e.g., install, delete, or update) the applications operating in the external device or the services provided by the external device (e.g., a call service or a message service).

In accordance with various embodiments of the present invention, the applications 134 include applications that are specified depending on properties (e.g., the type of the devices) of the external device. For example, if electronic device 104 is an MP3 player, the applications 134 may include an application related to music playback. Similarly, if the electronic device 104 is a mobile medical device, the applications 134 may include an application related to healthcare.

In one embodiment, the applications 134 may include at least one of an application specified to the electronic device 102 and an application received from the external device (e.g., server 106 or electronic device 104).

The I/O interface 140 sends the command or data that is received from the user through an I/O device (e.g., a sensor, a keyboard, a touch screen or the like) to the processor 120, the memory 130, or the communication interface 160 via, for example, the bus 110. For example, the I/O interface 140 provides the data for a user's touch that is input through the touch screen, to the processor 120. The I/O interface 140 may output the command or data that is received from the processor 120, the memory 130, or the communication interface 160, via the bus 110, through an I/O device (e.g., a speaker, a display or the like).

The display 150 displays a variety of information (e.g., multimedia data, text data or the like), on the electronic device 102 to the user. In accordance with an embodiment of the present invention, the display 150 may include a touch screen and a touch screen controller.

The touch screen receives a user's manipulation input, and displays the user interface, operating status, and menu status of an application program. In other words, the touch screen provides user interfaces, corresponding to various services (e.g., call, data transfer, broadcast, photo shooting, or the like), to the user. The touch screen sends an analog signal corresponding to at least one touch made on a user interface, to the touch screen controller. The touch screen may receive a touch input through at least one of the user's body (e.g., fingers including the thumb) and a touch input means, such as a pen (e.g., a stylus pen). The touch screen may receive, as an input, a continuous movement of any one of the at least one touch inputs. The touch screen sends an analog signal corresponding to the received continuous movement of a touch input to the touch screen controller.

According to the embodiments of the present invention, the touch input refers to a contact or a noncontact based gesture between the touch screen and the user's body or the touch input means. Accordingly, a touch input is not limited to actual contact between the touch screen and the user's body or the touch input means. For example, a hovering gesture is a noncontact based touch input.

In order to distinguish between a contact based touch input (hereinafter referred to as a touch event) and a noncontact based touch input (hereinafter referred to as a hovering event), the touch screen generates a different signal based on the distance detected between the touch screen and the user's body or the touch input means.

The touch screen may be implemented in, a resistive, capacitive, infrared, or acoustic wave manner.

The touch screen controller converts an analog signal received from the touch screen into a digital signal (e.g., X and Y coordinates), and sends the digital signal to the processor 120. The processor 120 controls the touch screen using the digital signal received from the touch screen controller. For example, the processor 120 causes a shortcut icon displayed on the touch screen to be selected, or executes the shortcut icon, in response to the touch event or the hovering event. The touch screen controller may be incorporated into the processor 120.

The touch screen controller detects a value (e.g., a current value or the like) that is output through the touch screen, to determine a distance between the touch screen and the space where the hovering event occurs, and converts the determined distance value into a digital signal (e.g., X, Y, and Z coordinates) and provides the digital signal to the processor 120.

The touch screen includes at least two touch screen panels, which can detect a touch by the user's body and proximity of the touch input means to the touch screen, thereby making it possible to simultaneously receive the touch and hovering inputs by the user's body and the touch input means. The at least two touch screen panels provide different output values to the touch screen controller, and the touch screen controller recognize the values received from the at least two touch screen panels differently. The touch screen controller may then determine whether an input from the touch screen is an input by the user's body or an input by the touch input means.

The communication interface 160 connects communication between the electronic device 102 and the external device (e.g., the electronic device 104 or the server 106). For example, the communication interface 160 communicates with the external device by being connected to a network 162 through wireless or wired communications. The wireless communications may include at least one of WiFi, Bluetooth (BT), Near Field Communication (NFC), Global Positioning System (GPS), and cellular communication (e.g., Long Term Evolution (LTE), Long Term Evolution Advanced (LTE-A), Code Division Multiple Access (CDMA), Wideband Division Multiple Access (WCDMA), Universal Mobile Telecommunications System (UMTS), Wireless Broadband (WiBro), Global System for Mobile (GSM) communication, or the like). The wired communications may include at least one of, for example, Universal Serial Bus (USB), High Definition Multimedia Interface (HDMI), Recommended Standard 232 (RS-232), and Plain Old Telephone Service (POTS).

In accordance with an embodiment of the present invention, the network 162 may be a telecommunications network. The telecommunications network may include at least one of a computer network, the Internet, the Internet of Things (IoT), and a telephone network. In one embodiment of the present invention, a protocol (e.g., a transport layer protocol, a data link layer protocol, or a physical layer protocol) for communication between the electronic device 102 and the external device is supported in at least one of the applications 134, the API 133, the middleware 132, the kernel 131, and the communication interface 160.

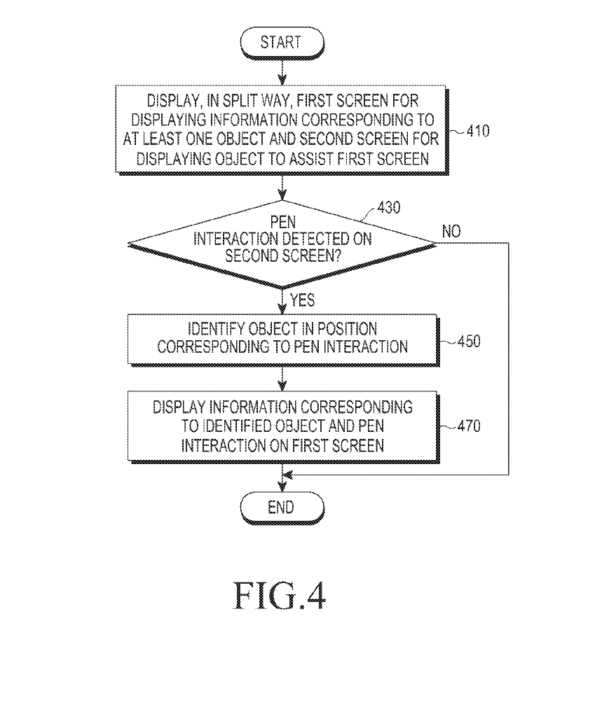

FIG. 4 is a flowchart illustrating a method of displaying a first screen and a second screen in an electronic device, according to various embodiments of the present invention.

Referring to FIG. 4, the electronic device 102 splits a screen into first and second screens and displays the screens. If a user selects a specific object on the second screen using a pen, the electronic device 102 newly displays a screen related to the selected object on the first screen, or changes the first screen to a screen related to the selected object, in response to the pen input and the selected object.

The object may include an icon, a widget, a notification indicator, indicating an event that has occurred in the electronic device 102, specified schedule information, content (e.g., photos, videos and the like), an edit item for editing of the first screen, an edit item for editing content displayed on the first screen, and metadata information of content displayed on the first screen.

In step 410, the electronic device 102 displays, in a split fashion, a first screen for displaying information corresponding to one or more objects and a second screen for displaying the objects to assist the first screen.

In step 430, the electronic device 102 determines whether it has detected a pen interaction on the second screen.

If a pen interaction is not detected on the second screen, then the electronic device 102 terminates the operation of the present invention.

If a pen interaction is detected on the second screen, then in step 450, the electronic device 102 identifies an object in a position corresponding to the pen interaction.

In step 470, the electronic device 102 displays information, corresponding to the identified object and the pen interaction, on the first screen.

For example, if the pen interaction is one which is set to display a specified preview screen for an object, the electronic device 102 displays a specified preview screen for the identified object on the first screen.

In another example, if the pen interaction is one which is set to display an execution screen for an object on the first screen, the electronic device 102 executes the identified object and displays an execution screen for the executed object on the first screen.

In yet another example, if the pen interaction is one which is set to display a preview screen for a case where a specified function of an object is applied to the first screen or to content displayed on the first screen, the electronic device 102 displays, on the first screen, a preview screen for a case where a specified function of the identified object is applied to the first screen or to content of the first screen.

In a final example, if the pen interaction is one which is set to apply a specified function of an object to the first screen or to content of the first screen, the electronic device 102 applies a specified function of the identified object to the first screen or to content of the first screen.

If a pen used for the pen interaction is not a pen approved to be used in the electronic device 102, the electronic device 102 avoids executing operations of the electronic device 102, such as the operation of identifying an object in a position corresponding to the pen interaction and the operation of displaying information corresponding to the identified object and the pen interaction on the first screen.

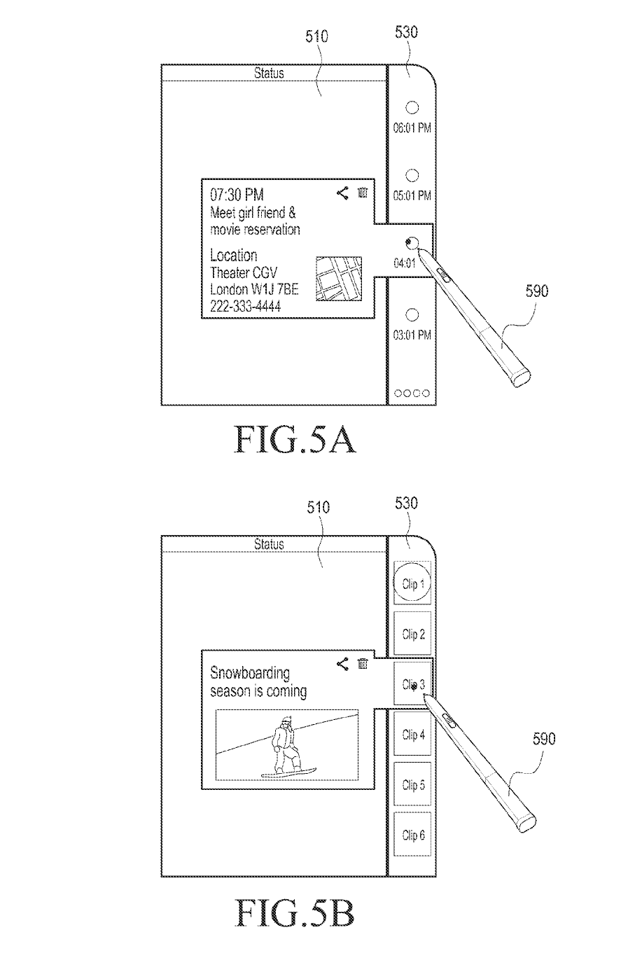

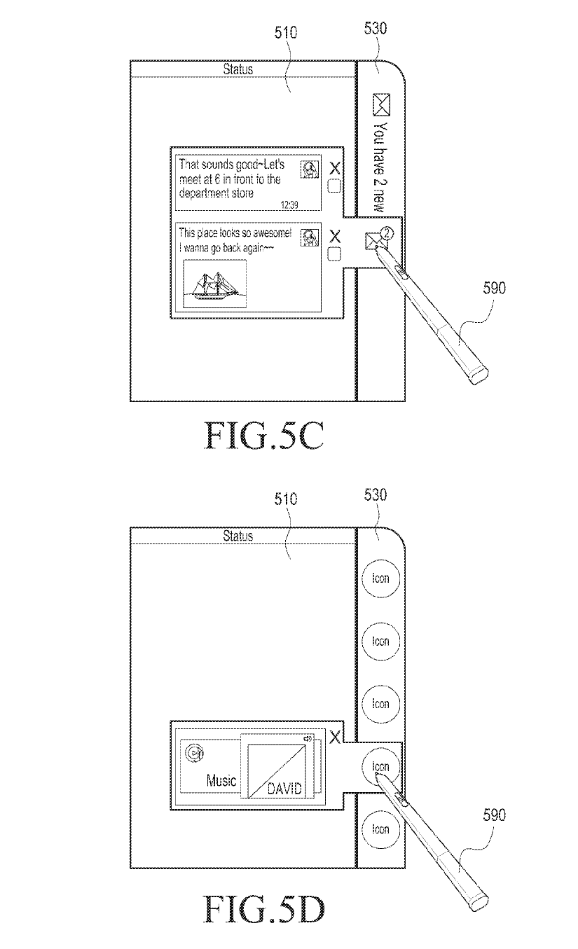

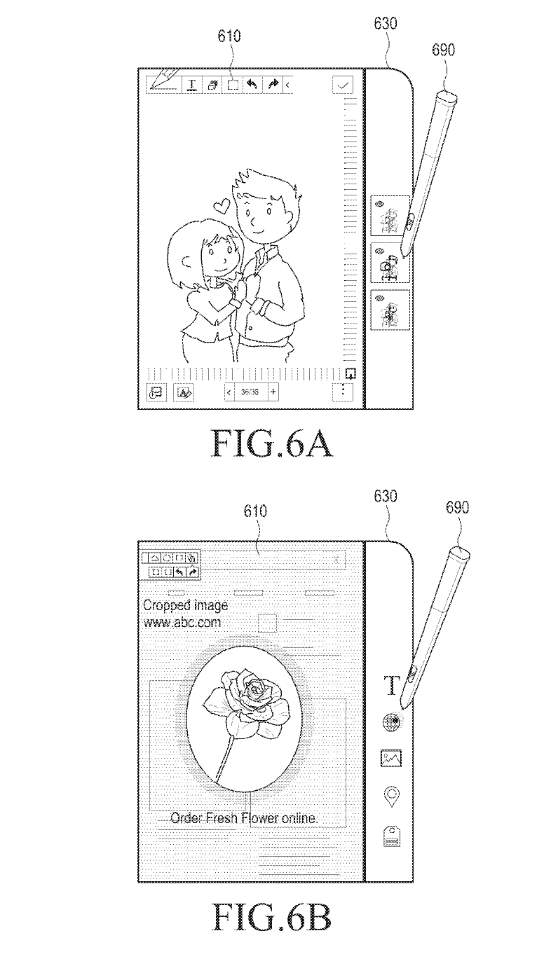

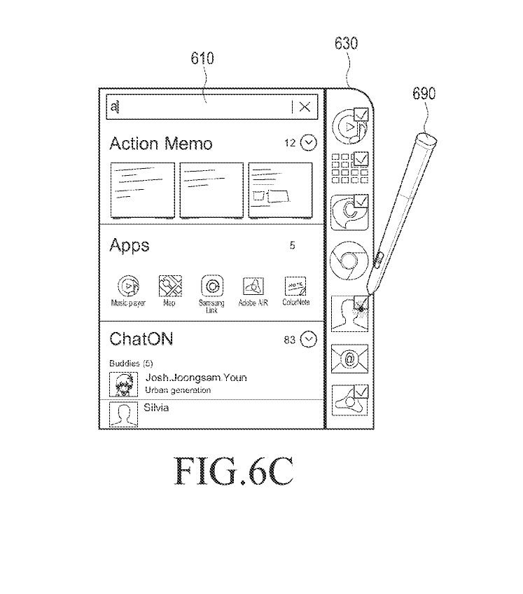

FIGS. 5A to 5D illustrate examples of screens of an electronic device in response to pen interactions, according to various embodiments of the present invention. FIGS. 6A to 6C illustrate additional examples of screens of an electronic device in response to pen interactions, according to various embodiments of the present invention;

Referring to FIGS. 5A to 6C, various examples of screens, which may be displayed on the electronic device 102, are provided to illustrate the above-described screen display operation of the electronic device 102.

Referring to FIG. 5A, the electronic device 102 may generate an icon for schedule information set by the user (hereinafter referred to as a ‘schedule icon’), and display one or more of the schedule icons on a second screen 530. If the user selects any one of the schedule icons displayed on the second screen 530 using a pen 590, the electronic device 102 detects a pen interaction, and displays detailed schedule information of the selected schedule icon on a first screen 510 using a preview screen in the form of a pop-up window.

Referring to FIG. 5B, the electronic device 102 may generate an item for a photo (hereinafter referred to as a ‘photo item’) that the user has saved, and display one or more of the photo items on the second screen 530. If the user selects any one of the photo items displayed on the second screen 530 using the pen 590, the electronic device 102 detects a pen interaction, and displays the selected photo on the first screen 510 using a preview screen in the form of a pop-up window.

Referring to FIG. 5C, upon detecting an occurrence of an event in which a new message is received at a specific application (e.g., a message application) of the electronic device 102, the electronic device 102 displays a notification indicator on the second display 530, indicating the receipt of the new message. If the user selects the notification indicator displayed on the second screen 530 using the pen 590, the electronic device 102 detects a pen interaction, and displays the notification associated with the selected notification indicator on the first screen 510 using a preview screen in the form of a pop-up window.

Referring to FIG. 5D, the electronic device 102 may display on the second screen 530, icons specified by the user or icons specified during the manufacturing of the electronic device 102. If the user selects any one of the icons displayed on the second screen 530 using the pen 590, the electronic device 102 detects a pen interaction, and displays application information of the selected icon on the first screen 510 using a preview screen in the form of a pop-up window.

Referring to FIG. 6A, the electronic device 102 may display content having a layer on a first screen 610, and display a layer list for each image effect on a second screen 630. If the user selects one image effect from the layer list displayed on the second screen 630 using a pen 690, the electronic device 102 detects a pen interaction, and displays on the first screen 610, a layer preview screen to be provided during application of the selected image effect, or a screen on which the selected image effect is applied.

In addition, the electronic device 102 may display on the second screen 630, an edit item (e.g., an image effect item capable of applying a specific effect, such as grayscale, blur, sharp, and vintage, to the first screen 610 or to content of the first screen 610) for editing the first screen 610 or content of the first screen 610. If the user selects one image effect from the edit item displayed on the second screen 630 using the pen 690, the electronic device 102 detects a pen interaction, and displays on the first screen 610, a preview screen to be provided during application of the selected image effect, or a screen on which the selected image effect is applied.

Referring to FIG. 6B, when scrapping an image, the electronic device 102 may generate an icon (hereinafter referred to as a ‘metadata icon’) corresponding to metadata information such as the scrap source information (e.g., Uniform Resource Locator (URL)), the scrap operation time, the electronic device's location during the scrap operation, and the text information, all of which are automatically included in the image, and display a corresponding metadata icon on the second screen 630. If the user selects any one of the icons (or multiple icons) from the metadata icons displayed on the second screen 630 and scraps a specific image, using the pen 690, then the electronic device 102 may detect a pen interaction, scrap an image such that metadata information corresponding to the selected metadata icon should be excluded from the image, and display the scrapped image on the first screen 610. Alternatively, if the user selects any one of the metadata icons displayed on the second screen 630 and scraps a specific image, using the pen 690, then the electronic device 102 may detect a pen interaction, scraps an image such that only the metadata information corresponding to the selected metadata icon should be included in the image, and display the scrapped image on the first screen 610. In the above-described operation, the pen interaction acts as a filter for selecting metadata information.

Referring to FIG. 6C, the electronic device 102 may display, on the second screen 630, icons specified by the user or icons specified during the manufacturing of the electronic device 102. If the user selects an icon whose execution screen is to be displayed on the first screen 610, from among the icons displayed on the second screen 630, using the pen 690, then the electronic device 102 detects a pen interaction, and displays an execution screen of an application for the selected icon on the first screen 610 in the form of a pop-up window. In addition, the electronic device 102 displays an image indicating the selection of the icon on the selected icon. In the above-described operation, the pen interaction acts as a filter for checking information to be displayed on the second screen 630.

In accordance with examples in FIGS. 5A to 6C, by applying the pen interaction to the second screen 530 or 630, the user may control and update information displayed on the first screen 510 or 610 without covering the first screen 510 or 610. In addition, the user may carefully check or execute the information related to the second screen 530 or 630 without altering the screen's main operating status displayed on the first screen 510 or 610. Further, in response to the pen interaction, the relevant information may be reflected in the first screen 510 or 610, or if a function existing on the second screen 530 or 630 is executed using a preview screen, the electronic device 102 may show the expected results in preview form.

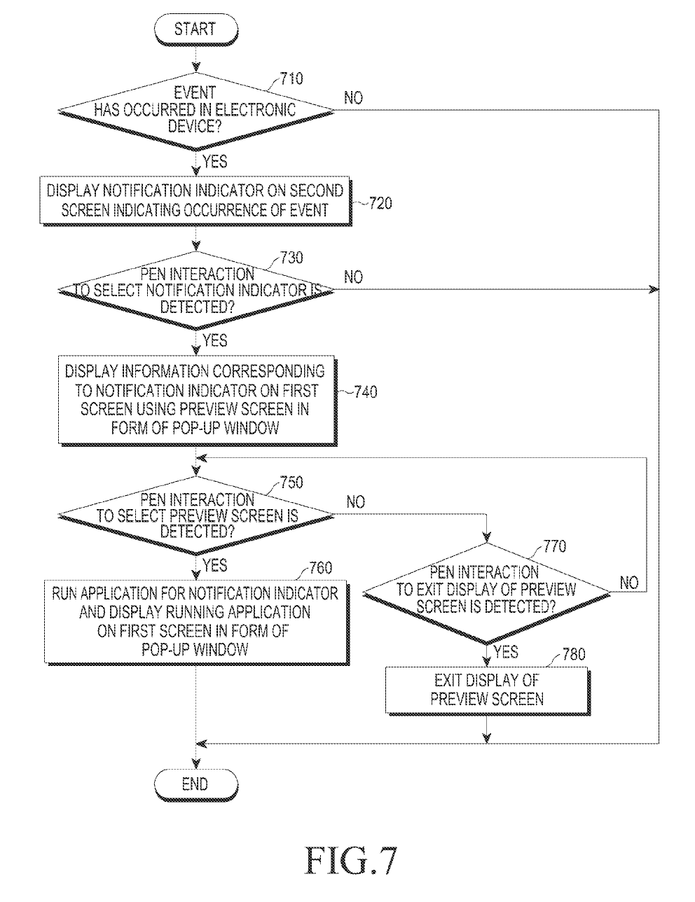

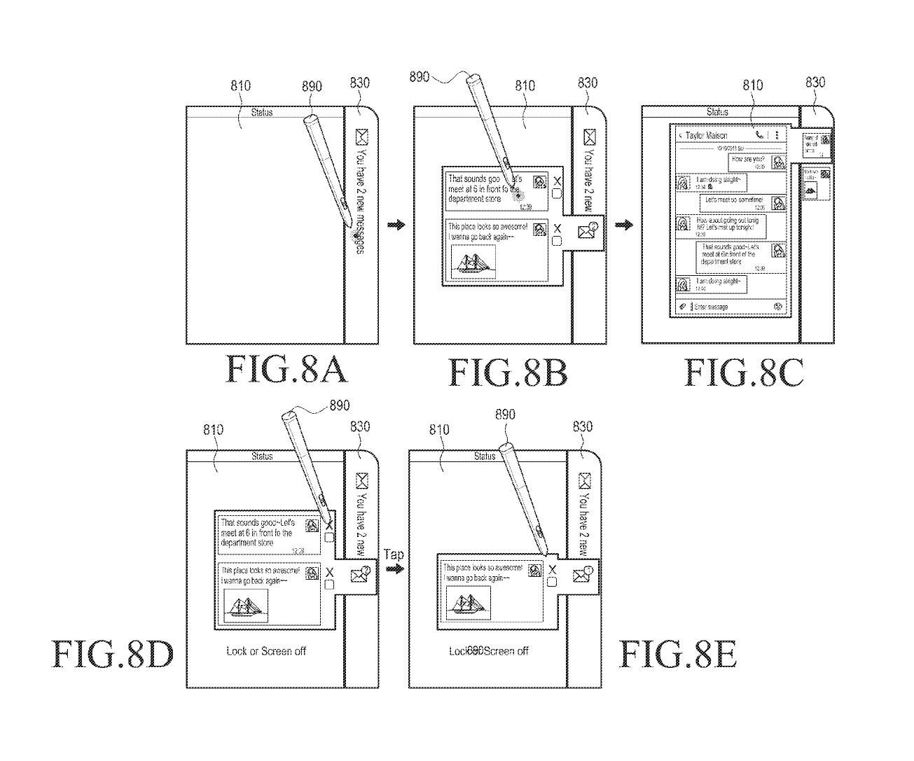

FIG. 7 is a flowchart illustrating a method of displaying screens in an electronic device, according to a first embodiment of the present invention. FIGS. 8A to 8E illustrate examples of screens of an electronic device, according to the first embodiment of the present invention.

Referring to FIGS. 7 and 8A to 8E, a screen of electronic device 102 is split into a first screen 810 and a second screen 830. FIGS. 8A to 8E illustrate examples of screens of electronic device 102, which are displayed when a specific event (e.g., message reception at a specific application, occurrence of an event for a specific application, or the like) has occurred in the electronic device 102.

Referring to FIGS. 7 and 8A to 8E, the electronic device 102 may display a notification indicator on the second screen 830, indicating an occurrence of a specific event. While displaying the notification indicator, the electronic device 102 displays a preview screen for the notification or an execution screen of an application to which the notification refers, on the first screen 810, in response to a pen interaction.

Referring to FIG. 7, in step 710, the electronic device 102 determines where an event has occurred in the electronic device 102.

If it is determined that an even has not occurred, the electronic device 102 terminates the operation of the present invention.

If it is determined that an event has occurred, then in step 720 the electronic device 102 displays notification indicator of a specified type, which indicates the occurrence of the event, on the second screen 830.

For example, the screen of the electronic device 102 is split into the first screen 810 and the second screen 830, as illustrated in FIGS. 8A to 8E. Upon the occurrence of the event of receiving two new messages, the electronic device 102 displays a notification indicator on the second screen 830, indicating the reception of the two new messages, as illustrated in FIG. 8A.

In step 730, the electronic device 102 determines whether a pen interaction is detected to select the notification indicator.

If the pen interaction is not detected, the electronic device 102 terminates the operation of the present invention.

If the pen interaction is detected, then in step 740, the electronic device 102 displays information corresponding to the notification indicator on the first screen 810, using a preview screen in the form of a pop-up window.

For example, if the user selects the notification indicator, indicating the reception of two new messages, using a pen 890, as illustrated in FIG. 8A, the electronic device 102 displays the two new messages on the first screen 810, in two separate preview screens in the form of a pop-up window, as illustrated in FIG. 8B.

In step 750, the electronic device 102 determines whether a pen interaction is detected to select one of the preview screens displayed on the first screen 810.

If it is determined that the electronic device 102 has detected a pen interaction to select a preview screen, then in step 760, the electronic device 102 runs an application associated with the selected preview screen, and displays the running application on the first screen 810, in the form of a pop-up window.

For example, if the user selects one of the preview screens using the pen 890, as illustrated in FIG. 8B, the electronic device 102 displays an execution screen of an application for the selected preview screen on the first screen 810 in the form of a pop-up window, as illustrated in FIG. 8C. For example, if the selected preview screen corresponds to a text message application, this screen display operation displays an execution screen for the text message application on the second screen 830. The execution screen may include multiple text messages associated with the selected new message, as illustrated in FIG. 8C.

If it is determined that the a pen interaction to select one of the preview screens is not detected, in step 750, then in step 770, the electronic device 102 determines whether a pen interaction to exit the display of one of the preview screens is detected.

If it is determined that a pen interaction to exit the display of one of the preview screens is not detected, the electronic device 102 returns to step 750.

For example, if the user selects a display exit button displayed on one of the preview screens using the pen 890, as illustrated in FIG. 8D, the electronic device 102 exits the display of the preview screen for which the display exit button is selected, as illustrated in FIG. 8E.

If it is determined that a pen interaction to exit the display of one of the preview screens is detected, then in step 780, the electronic device 102 exits the display of the preview screen displayed on the first screen 810 for which the display exit button is selected.

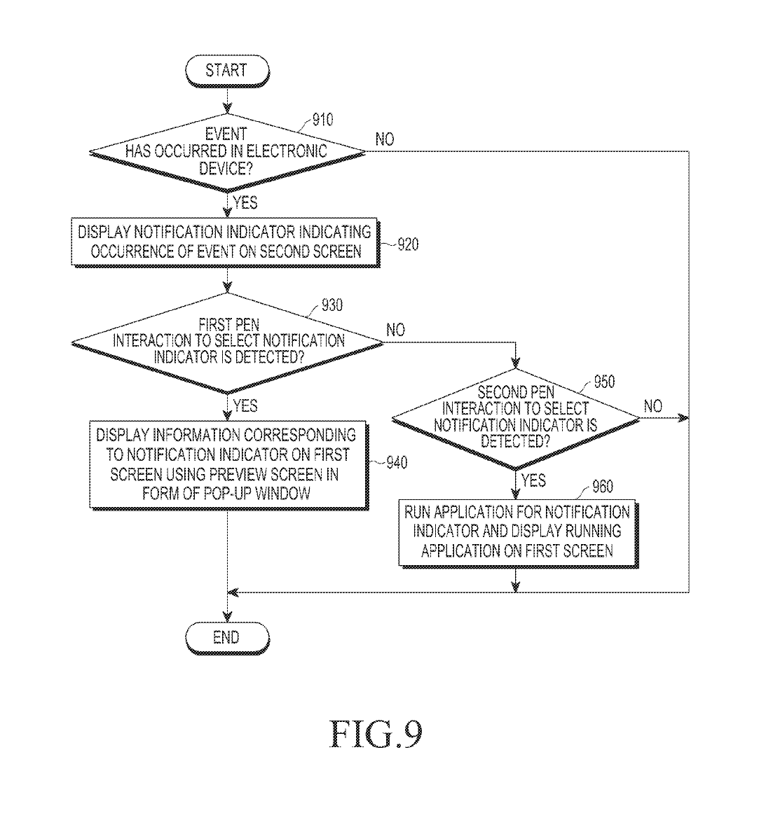

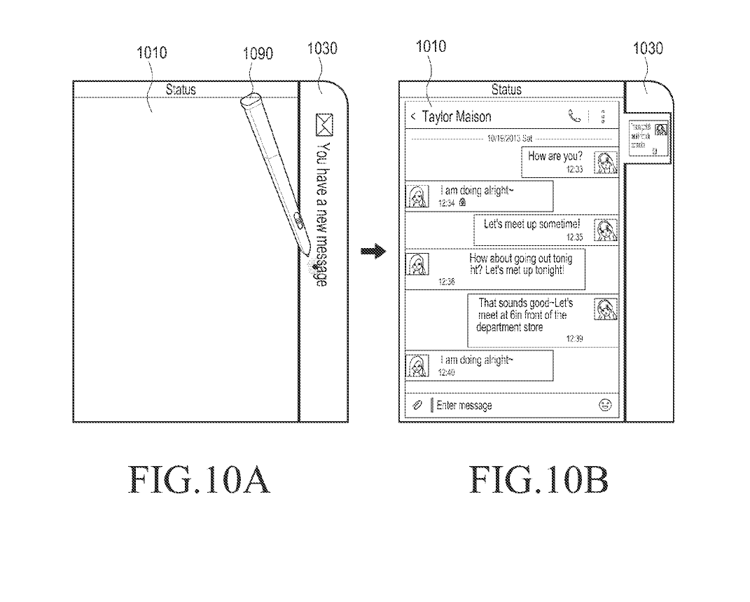

FIG. 9 is a flowchart illustrating a method of displaying screens in an electronic device, according to a second embodiment of the present invention. FIGS. 10A and 10B illustrate examples of screens of an electronic device, according to the second embodiment of the present invention.

Referring to FIGS. 9, 10A and 10B, a screen of electronic device 102 is split into a first screen 1010 and a second screen 1030. FIGS. 10A and 10B illustrate examples of screens electronic device 102, which are displayed when a specific event has occurred in the electronic device 102.

Referring to FIGS. 9, 10A and 10B, the electronic device 102 displays a notification indicator on the second screen 1030, indicating an occurrence of a specific event. While displaying the notification indicator, the electronic device 102 displays a preview screen for the notification associated with the notification indicator or an execution screen of an application for which the notification indicator is related on the first screen 1010, in response to the type of a pen interaction. For example, if a tap input by a pen 1090 is made in the location where the notification indicator is displayed, the electronic device 102 may display a preview screen for the notification associated with the notification indicator on the first screen 1010. If a hovering input by the pen 1090 is made in the location where the alarm message is displayed, the electronic device 102 may display an execution screen of an application for which the notification indicator is related on the first screen 1010.

Referring to FIG. 9, in step 910, the electronic device 102 determines whether an event has occurred in the electronic device 102.

If it is determined that an event has not occurred, the electronic device 102 terminates the operation of the present invention.

If it is determined that an event has occurred, then in step 920, the electronic device 102 displays a notification indicator of a specified type on the second screen 1030, which indicates the occurrence of the event.

For example, the screen of the electronic device 102 is split into the first screen 1010 and the second screen 1030, as illustrated in FIGS. 10A and 10B. Upon receiving a new message, the electronic device 102 displays an notification indicator on the second screen 1030, indicating the reception of the new message, as illustrated in FIG. 10A.

In step 930, the electronic device 102 determines whether the electronic a first pen interaction to select a notification indicator is selected.

If it is determined that a first pen interaction to select a notification indicator is selected, then in step 940, the electronic device 102 displays information corresponding to the notification indicator on the first screen 1010 using a preview screen in the form of a pop-up window.

If it is determined that a first pen interaction to select a notification indicator is not selected, then in step 950, the electronic device 102 determines whether a second pen interaction to select a notification indicator is detected.

If it is determined that a second pen interaction to select a notification indicator is not selected, then the electronic device 102 terminates the operation of the present invention.

If it is determined that a second pen interaction to select a notification indicator is selected, then in step 960, the electronic device 102 runs an application for which the notification indicator is related, and display the running application on the first screen 1010 in the form of a pop-up window.

For example, if the user selects an notification indicator indicating the presence of a new message by using the pen 1090 to provide a pen interaction to display an execution screen of an application associated with the notification, as illustrated in FIG. 10A, the electronic device 102 displays an execution screen of an application for the message on the first screen 1010 in a full screen, as illustrated in FIG. 10B. While displaying the execution screen on the first screen 1010, the electronic device 102 displays a preview screen on the second screen 1030, including information corresponding to the notification, as illustrated in FIG. 10B.

Referring to FIGS. 7 to 10B, as for the information displayed on the screen of the electronic device 102, the electronic device 102 controls or utilizes the content in response to the pen interaction on the first screen 810 (or 1010) or the second screen 830 (or 1030).

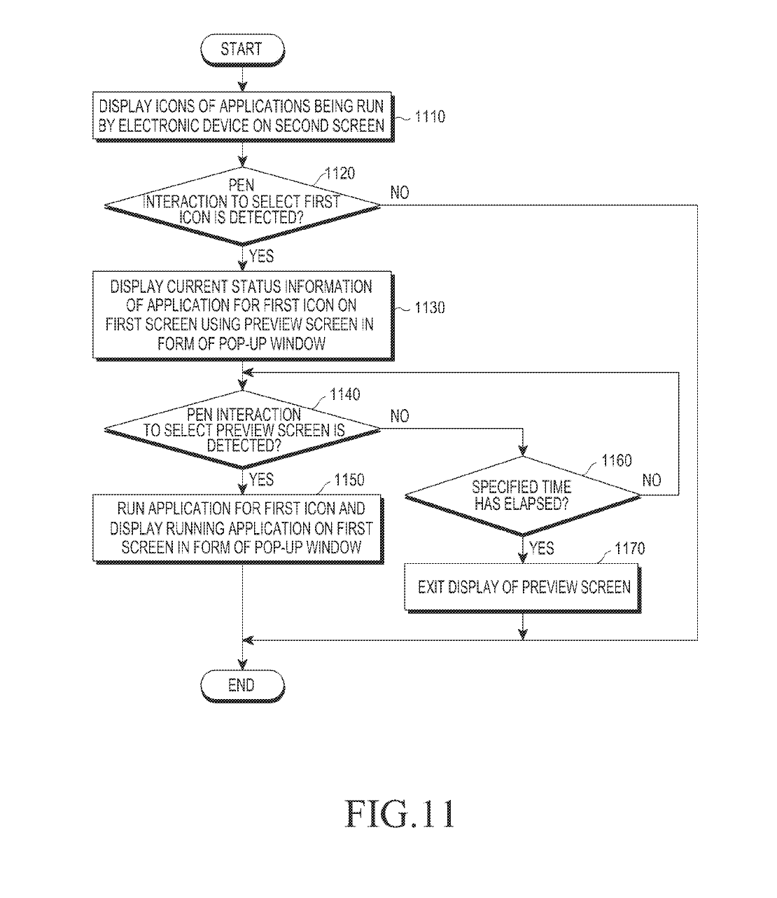

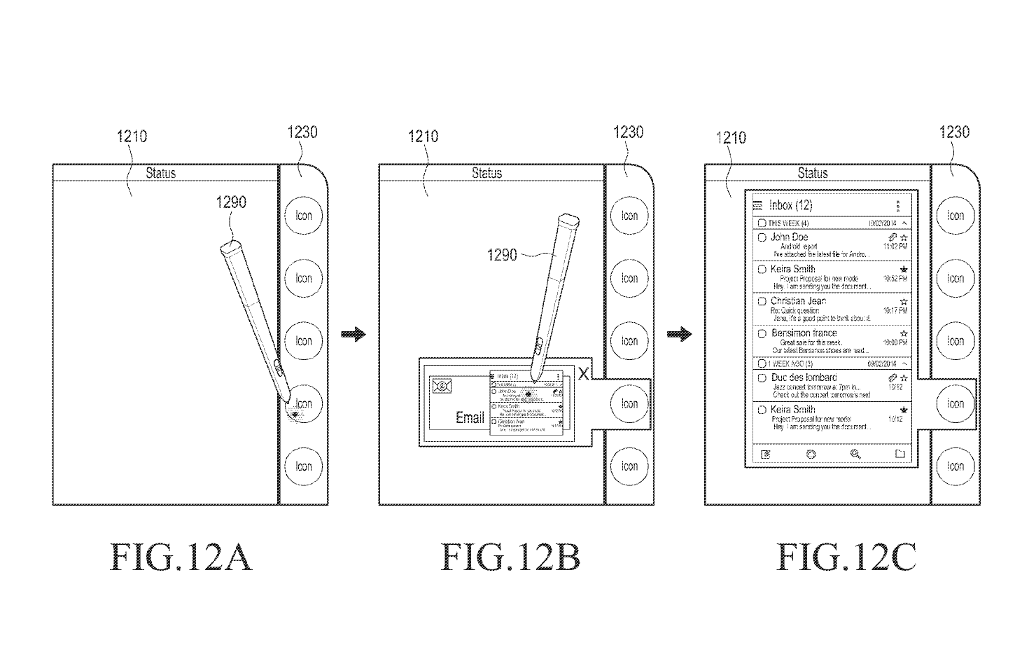

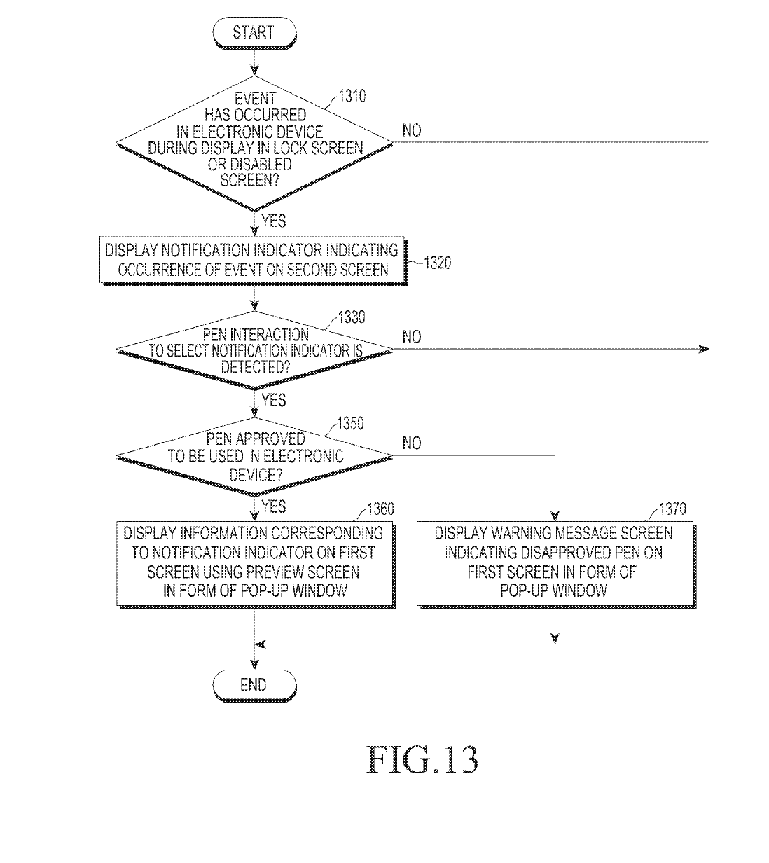

FIG. 11 is a flowchart illustrating a method of displaying screens in an electronic device, according to a third embodiment of the present invention. FIGS. 12A to 12C illustrate examples of screens of an electronic device, according to the third embodiment of the present invention.

Referring to FIGS. 11 and 12A to 12C, a screen of an electronic device 102 is split into a first screen 1210 and a second screen 1230. FIGS. 12A and 12C illustrate examples of screens of electronic device 102 in a case where specific icons are displayed on the second screen 1230. The specific icons displayed on the second screen 1230 may be icons of the applications that the user is running. In this case, when the user runs an application, the electronic device 102 displays an icon of the application on the second screen 1230. Alternatively, the specific icons displayed on the second screen 1230 may be icons of the applications that the user has selected.

Referring to FIGS. 11 and 12A to 12C, the electronic device 102 displays icons of the running applications on the second screen 1230. While icons of the applications are displayed, the electronic device 102 displays the current status information of an application associated with a displayed icon on a preview screen or displays an execution screen in form of a pop-up window of an application associated with a displayed icon on the first screen 1210, in response to a pen interaction. The display of the execution screen in form of a pop-up window of the application on the first screen 1210 provides a multitasking function to the user so that the user may perform the function that is equivalent in level to the functions used in the displayed screen by running applications.

Referring to FIG. 11, in step 1110, the electronic device 102 display icons of the applications that the electronic device 102 is running, on the second screen 1230.

For example, the screen of the electronic device 102 is split into the first screen 1210 and the second screen 1230, as illustrated in FIGS. 12A to 12C, and icons of running applications are displayed on the second screen 1230.

In step 1120, the electronic device 102 determines whether a pen interaction to select a first icon is detected.

If it is determined that a pen interaction to select a first icon is not detected, the electronic device 102 terminates the operation of the present invention.

If it is determined that a pen interaction to select a first icon is detected, then in step 1130, the electronic device 102 displays the current status information of an application for the first icon on the first screen 1210 using a preview screen in the form of a pop-up window.

For example, if the user selects one of the icons displayed on the second screen 1230 using a pen 1290, as illustrated in FIG. 12A, the electronic device 102 displays the current status information of an application for the icon on the first screen 1210 using a preview screen in the form of a pop-up window, as illustrated in FIG. 12B.

In step 1140, the electronic device 102 determines whether the electronic device 102 has detected a pen interaction to select a preview screen.

If it is determined that a pen interaction to select a preview screen is detected, then in step 1150, the electronic device 102 runs an application for the first icon associated with the preview screen, and displays the running application on the first screen 1210 in the form of a pop-up window.

For example, if the user selects a preview screen using the pen 1290, as illustrated in FIG. 12B, the electronic device 102 displays an execution screen of an application on the first screen 1210 in the form of a pop-up window, as illustrated in FIG. 12C.

If it is determined that a pen interaction to select a preview screen is not detected in step 1140, then in step 1160, the electronic device 102 determines whether a specified time (e.g., the time that is set by the user or was specified during the manufacturing) has elapsed.

If it is determined that the specified time has not elapsed, then the electronic device 102 returns to step 1140.

If it is determined that the specified time has elapsed, then in step 1170, the electronic device 102 exits the display of the preview screen.

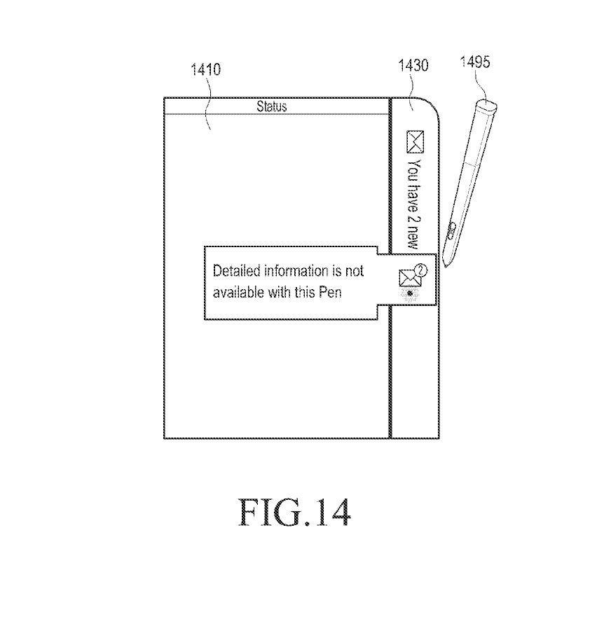

FIG. 13 is a flowchart illustrating a method of displaying screens in an electronic device, according to a fourth embodiment of the present invention. FIG. 14 illustrates an example of a screen of an electronic device, according to the fourth embodiment of the present invention.

Referring to FIGS. 13 and 14, a screen of electronic device 102 is split into a first screen 1410 and a second screen 1430. FIG. 14 illustrates an example of a screen of electronic device 102, which is displayed when a specific event has occurred in the electronic device 102.

Referring to FIGS. 13 and 14, the electronic device 102 displays a notification indicator on the second screen 1430, indicating an occurrence of a specific event. While displaying the notification indicator, the electronic device 102 displays a specific screen for the notification associated with the notification indicator on the first screen 1410, or does not display a specific screen, in response to a pen interaction.

Referring to FIG. 13, in step 1310, the electronic device 102, while displaying a lock screen or a disabled screen, determines whether an event has occurred in the electronic device 102.

If it is determined that no event has occurred, then the electronic device 102 terminates the operation of the present invention.

If it is determined that an event has occurred, then in step 1320, the electronic device 102 displays a notification indicator on the second screen 1430, indicating the occurrence of an event.

In step 1330, the electronic device 102 determines whether a pen interaction to select a notification indicator is detected.

If it is determined that a pen interaction to select a notification indicator is not detected, then the electronic device 102 terminates the operation of the present invention.

If it is determined that a pen interaction to select a notification indicator is detected, then in step 1350, the electronic device 102 determines whether a pen used for the pen interaction is a pen approved to be used in the electronic device 102.

The electronic device 102 may be set, during its manufacturing or by the user's manipulation, to operate in response only to a pen interaction by a specific pen. For example, the electronic device 102 may approve only a specific pen to execute functions of the electronic device 102, and may prevent pens other than the approved pen from executing the functions of the electronic device 102. The pen may have a chip including the information based on which the pen can be identified, and the electronic device 102 may determine whether a pen used for a pen interaction is a pen approved to be used in the electronic device 102, through the operation with the pen (e.g., depending on the signal waveform).

If it is determined that the pen used for the pen interaction is a pen approved to be used in the electronic device 102, then in step 1360, the electronic device 102 displays information corresponding to the notification indicator on the first screen 1410 using a preview screen in the form of a pop-up window.

If it is determined that the pen used for the pen interaction is not a pen approved to be used in the electronic device 102, then in step 1370, the electronic device 102 displays on the first screen 1410 a warning message screen in the form of a pop-up window, which indicates that the pen is not an approved pen. In this case, the electronic device 102 does not perform the operation of displaying information corresponding to the notification indicator on the first screen 1410.

For example, if a disapproved pen 1495 is in close proximity to the electronic device 102, as illustrated in FIG. 14, the electronic device 102 displays a warning message on the first screen 1410, without displaying detailed information corresponding to the notification indicator. As illustrated in FIG. 14, while displaying the warning message, the electronic device continues to display the notification indicator on the second screen 1430.

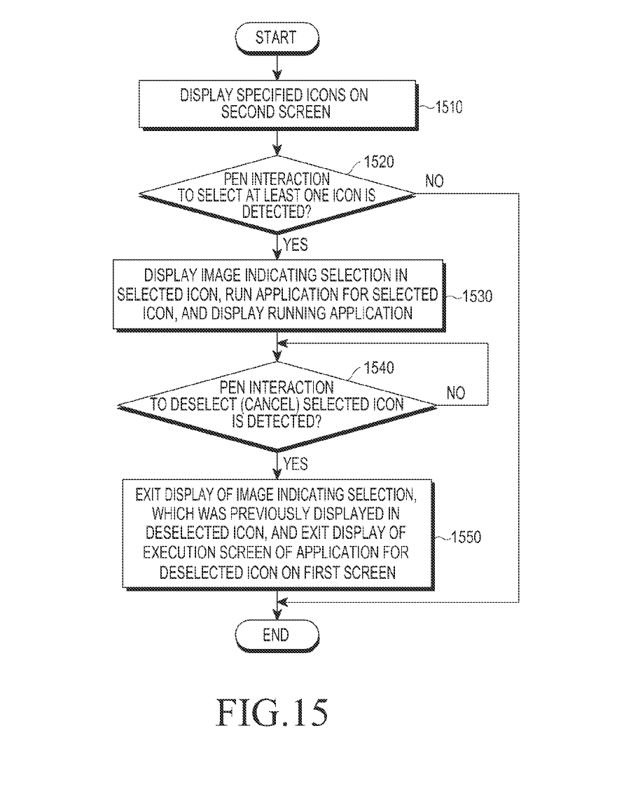

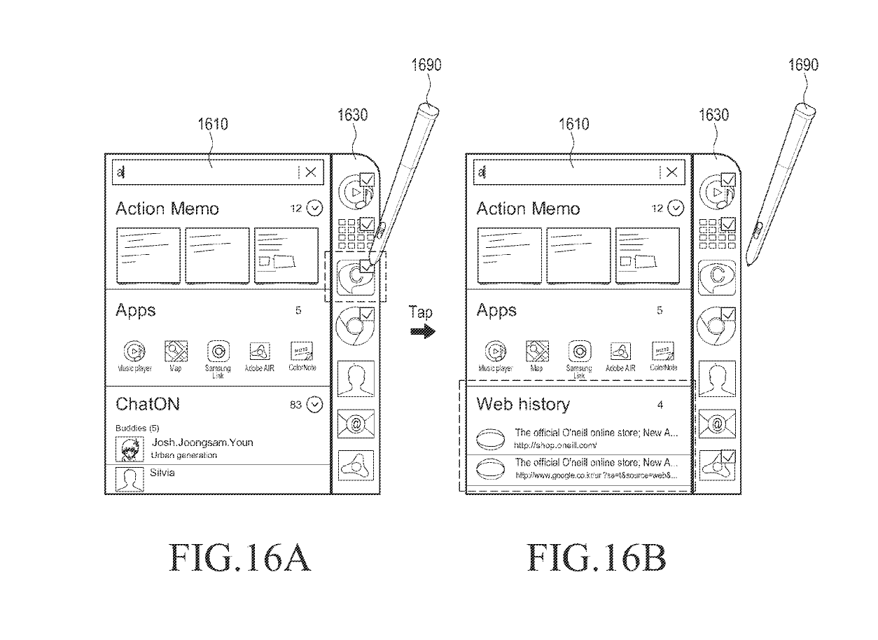

FIG. 15 is a flowchart illustrating a method of displaying screens in an electronic device, according to a fifth embodiment of the present invention. FIGS. 16A and 16B illustrate examples of screens of an electronic device, according to the fifth embodiment of the present invention.

Referring to FIGS. 15, 16A and 16B, a screen of electronic device 102 is split into a first screen 1610 and a second screen 1630. FIGS. 16A and 16B illustrate examples of screens of electronic device 102 in a case where specific icons are displayed on the second screen 1630. The specific icons displayed on the second screen 1630 may be icons of the applications that the user is running, or may be icons which are specified during the manufacturing of the electronic device 102 or specified by the user. Alternatively, the specific icons may be icons that the electronic device 102 has automatically selected in order of high execution frequency by checking the user's application execution frequency.

Referring to FIGS. 15, 16A and 16B, the electronic device 102 displays icons of the running applications on the second screen 1630, and displays, on the first screen 1610, execution screens of applications associated with icons that are selected in response to a pen interaction. If the first screen 1610 is not large enough in size to display the execution screens of the applications associated with the selected icons, then the electronic device 102 displays the execution screens of the applications associated with higher-priority icons, based on the priorities of the selected icons. In addition, if icons are selected in response to a pen interaction, the electronic device 102 displays an image indicating the selection in the selected icons. The selected icons may additionally be deselected in response to a pen interaction. If the selected icons are deselected, the electronic device 102 terminates the display of the execution screens of the applications associated with the deselected icons on the first screen 1610.

Referring to FIG. 15, in step 1510, the electronic device 102 displays icons, specified by the user, on the second screen 1630.

In operation 1520, the electronic device 102 determines whether a pen interaction to select at least one icon has been detected.

If the pen interaction to select at least one icon has not been detected, then the electronic device 102 terminates the operation of the present invention.

If the pen interaction to select at least one icon has been detected, then in step 1530, the electronic device 102 displays an image indicating the selection in the selected icon, and runs an application for the selected icon, and displays the running application on the first screen 1610. The execution screen of the application that is displayed on the first screen 1610 may be a full execution screen or a partial execution screen. In the case when a partial execution screen is displayed, a button for displaying the full execution screen may be displayed on the partial execution screen.

For example, as illustrated in FIG. 16A, if the user selects an icon displayed on the second icon 1630 using a pen 1690, the electronic device 102 displays a check box in the selected icon. The electronic device 102 displays screens (e.g., some of the execution screens of applications) on the first screen 1610, corresponding to the applications for the selected icons. If the electronic device 102 cannot display all of the screens corresponding to the applications for the selected icons, due to the limited size of the first screen 1610, the electronic device 102 displays only the screens corresponding to specific applications, depending on specified conditions.

In step 1540, the electronic device 102 determines whether a pen interaction to deselect (or cancel the selection of) the selected icons is detected.

If it is determined that a pen interaction to deselect the selected icons is not detected, then the electronic device 102 may again perform step 1540.

If it is determined that a pen interaction to deselect the selection icons is detected, then in step 1550, the electronic device 102 removes the display of the image indicating the selection in the deselected icon, and terminates the display of the execution screen of the application associated with the deselected icon on the first screen 1610.

For example, if the user deselects a selected icon by selecting an icon in which a check box is displayed, using a pen 1690, as illustrated in FIG. 16A, the electronic device 102 removes the display of the check box in the deselected icon, as illustrated in FIG. 16B. In addition, the electronic device 102 terminates the display of the execution screen corresponding to the application associated with the deselected icon on the first screen 1610. Further, in the location on the first screen 1610 where the terminated execution screen was displayed, a execution screen corresponding to an application of another icon which was selected but not displayed on the first screen 1610 may be displayed.

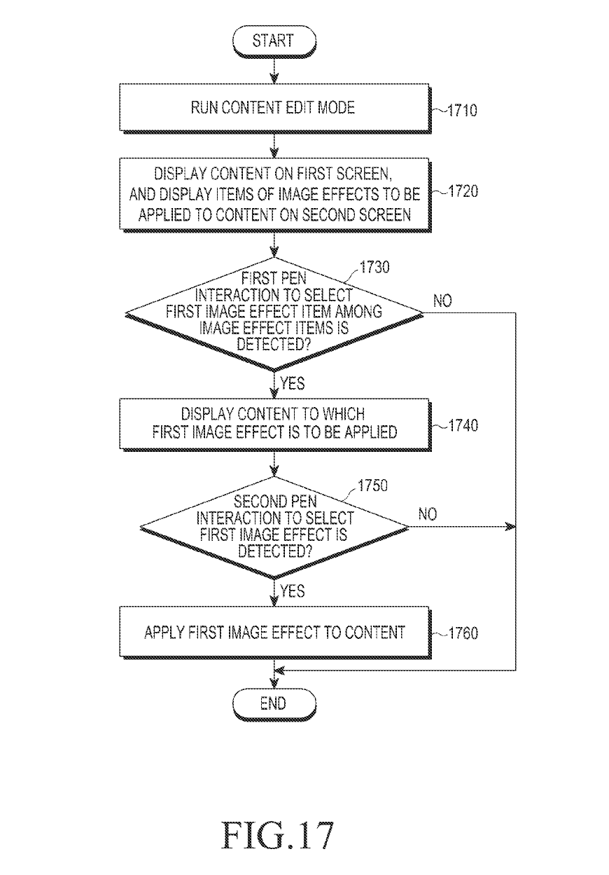

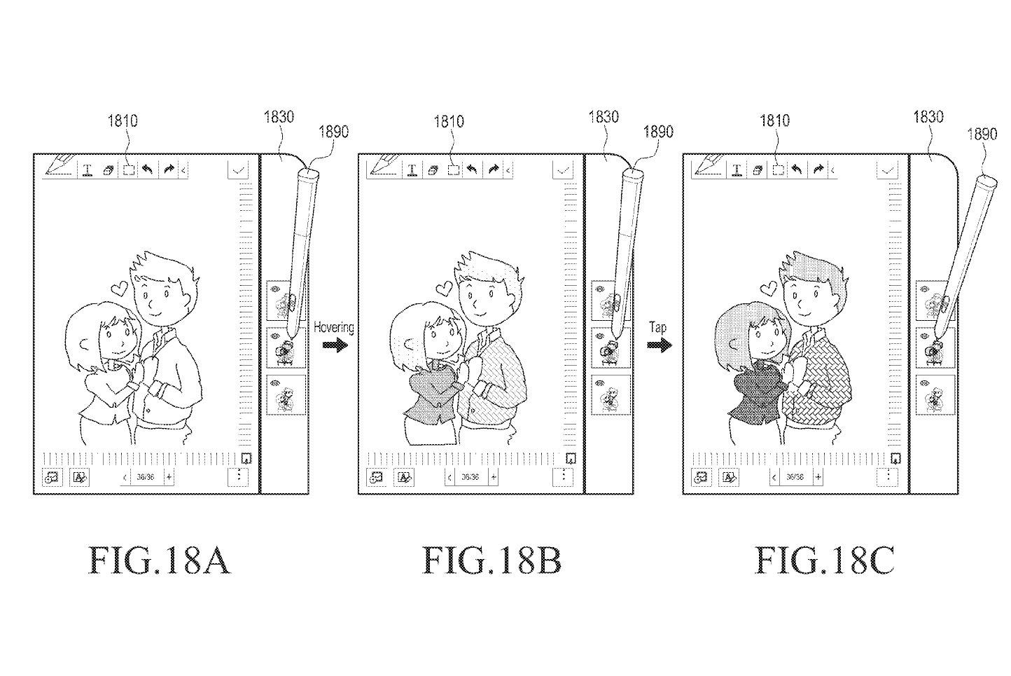

FIG. 17 is a flowchart illustrating a method of displaying screens in an electronic device, according to a sixth embodiment of the present invention. FIGS. 18A to 18C illustrate examples of screens of an electronic device, according to the sixth embodiment of the present invention.

Referring to FIGS. 17 and 18A to 18C, a screen of electronic device 102 is split into a first screen 1810 and a second screen 1830. FIGS. 18A to 18C illustrate examples of screens of electronic device 102, which are displayed in response to the user's manipulation for editing the first screen 1810 of the electronic device 102 or editing the content displayed on the first screen 1810.

Referring to FIGS. 17 and 18A to 18C, the electronic device 102 displays, on the second screen 1830, an edit item for editing the first screen 1810 or editing content displayed on the first screen 1810, through execution of a specific application or a specific function of the electronic device 102. On the second screen 1830, the electronic device 102 displays a preview screen to which editing effects corresponding to the edit item selected in response to a pen interaction are applied, or displays a screen to which editing effects corresponding to the edit item selected in response to a pen interaction are to be applied.

Referring to FIG. 17, in step 1710, the electronic device 102 runs a content edit mode in response to the user's manipulation.

In step 1720, the electronic device 102 displays content on the first screen 1810, and display editing effects (e.g., an image effect item) to be applied to the content, on the second screen 1830.

For example, if the user runs a specific application for image editing, the electronic device 102 displays a screen, as illustrated in FIG. 18A. Referring to FIG. 18A, the electronic device 102 displays various image effect items such as black & white, vintage, and sepia, on the second screen 1830, and displays an image to be edited, on the first screen 1810.

In step 1730, the electronic device 102 determines whether a first pen interaction to select first image effects among the image effect items is detected.

If it is determined that a first pen interaction to select first image effects is not detected, then the electronic device 102 terminates the operation of the present invention.

If it is determined that a first pen interaction to select first image effects is detected, then in step 1740, the electronic device 102 displays content to which the first image effects are to be applied.

For example, if the user selects any one of the image effects by entering a manipulation using a pen 1890, which is set to display a preview screen, to which image effects are to be applied, as illustrated in FIG. 18A, the electronic device 102 displays, on the first screen 1810, a preview screen where the selected image effects are to be applied to content, as illustrated in FIG. 18B.

In step 1750, the electronic device 102 determines whether a second pen interaction to select first image effects is detected.

If it is determined that a second pen interaction to select first image effects is not detected, then the electronic device 102 terminates the operation of the present invention.

If it is determined that a second pen interaction to select first image effects is detected, then in step 1760, the electronic device 102 applies the first image effects to the content displayed in the first screen 1810.

For example, if the user selects any one of the image effects by entering a manipulation using the pen 1890, which is set to apply image effects, as illustrated in FIG. 18B, the electronic device 102 displays the content, to which the selected image effects are applied, on the first screen 1810, as illustrated in FIG. 18C.

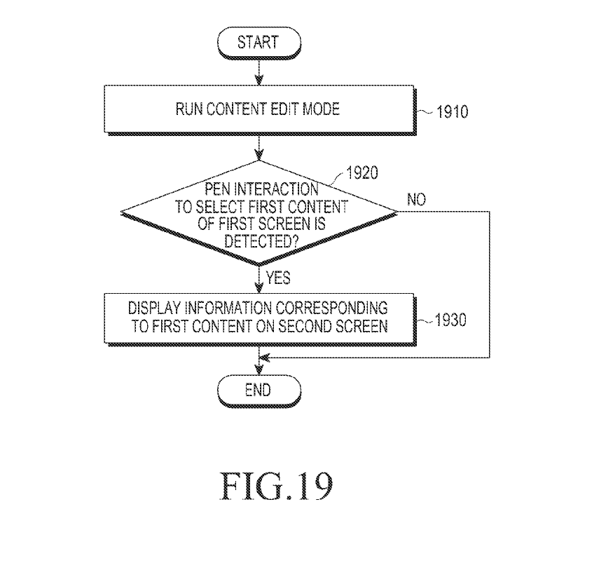

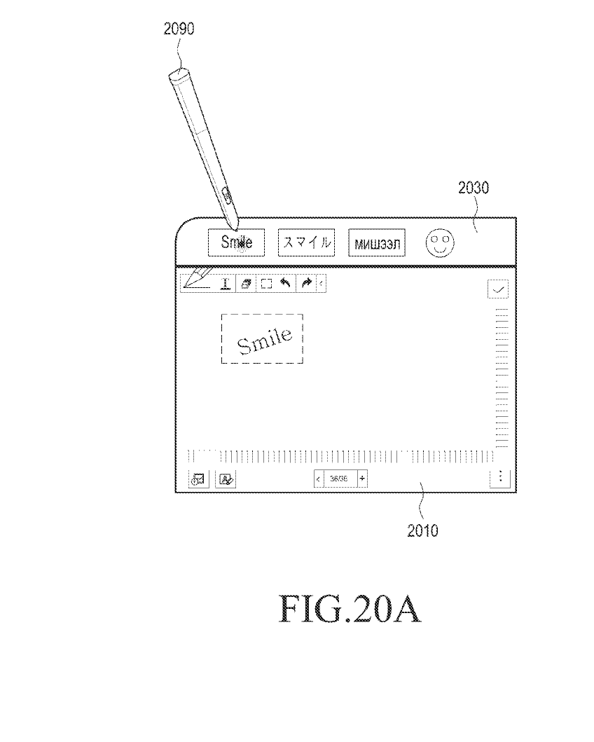

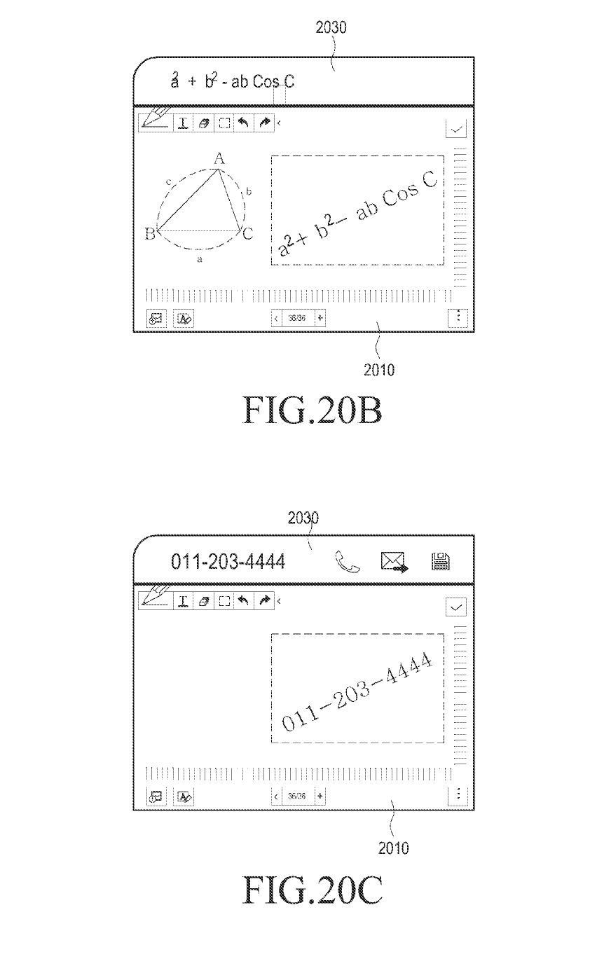

FIG. 19 is a flowchart illustrating an operation of displaying screens in an electronic device, according to a seventh embodiment of the present invention. FIGS. 20A to 20C illustrate examples of screens of an electronic device, according to the seventh embodiment of the present invention.

Referring to FIGS. 19 and 20A to 20C, a screen of electronic device 102 is split into a first screen 2010 and a second screen 2030. FIGS. 20A and 20C illustrate examples of screens of electronic device 102, which are displayed in response to the user's manipulation entered to the first screen 2010.

Referring to FIGS. 19 and 20A to 20C, the electronic device 102 displays information on the second screen 2030, which is reflected in the first screen 2010, in response to a pen interaction.

Referring to FIG. 19, in step 1910, the electronic device 102 runs a content edit mode.

In step 1920, the electronic device 102 determines whether a pen interaction to select first content of the first screen 2010 is detected.

If it is determined that a pen interaction to select first content of the first screen 2010 is not detected, then the electronic device 102 terminates the operation of the present invention.

If it is determined that a pen interaction to select first content of the first screen 201 is detected, then in step 1930, the electronic device 102 displays at least one piece of information corresponding to the first content on the second screen 2030.

For example, if the user runs a specific application for notes, the electronic device 102 displays a screen as illustrated in FIG. 20A. If the user inputs the word to the first screen 2010 using a pen 2090, the electronic device 102 displays, on the second screen 2030, the English translation for the input word, the Japanese translation for the input word, an emoticon corresponding to the input word, and the like. If the user selects the translated English word ‘Smile’, as illustrated in FIG. 20A, using the pen 2090, the electronic device 102 displays the word ‘Smile’, translated from the word on the first screen 2010.

In another example, if the user runs a specific application for notes, the electronic device 102 displays a screen including the first screen 2010 on which an equation is written, as illustrated in FIG. 20B. If the user selects the equation using the pen 2090, the electronic device 102 recognizes the equation and displays the selected equation on the screen 2030.

In another example, if the user runs a specific application for notes, the electronic device 102 displays a screen including the first screen 2010 on which a phone number is written, as illustrated in FIG. 20C. If the user selects the phone number using the pen 2920, the electronic device 102 displays the phone number on the second screen 2030, and also displays, on the second screen 2030, an icon for making a call to the displayed phone number, an icon for sending a written text or e-mail to the displayed phone number, an icon for saving the displayed phone number in a contacts application installed in the electronic device 102, and the like. E-mail addresses, Internet addresses (or URLs), general addresses and the like may also be written on the first screen 2010, and the above-described method may be applied thereto.

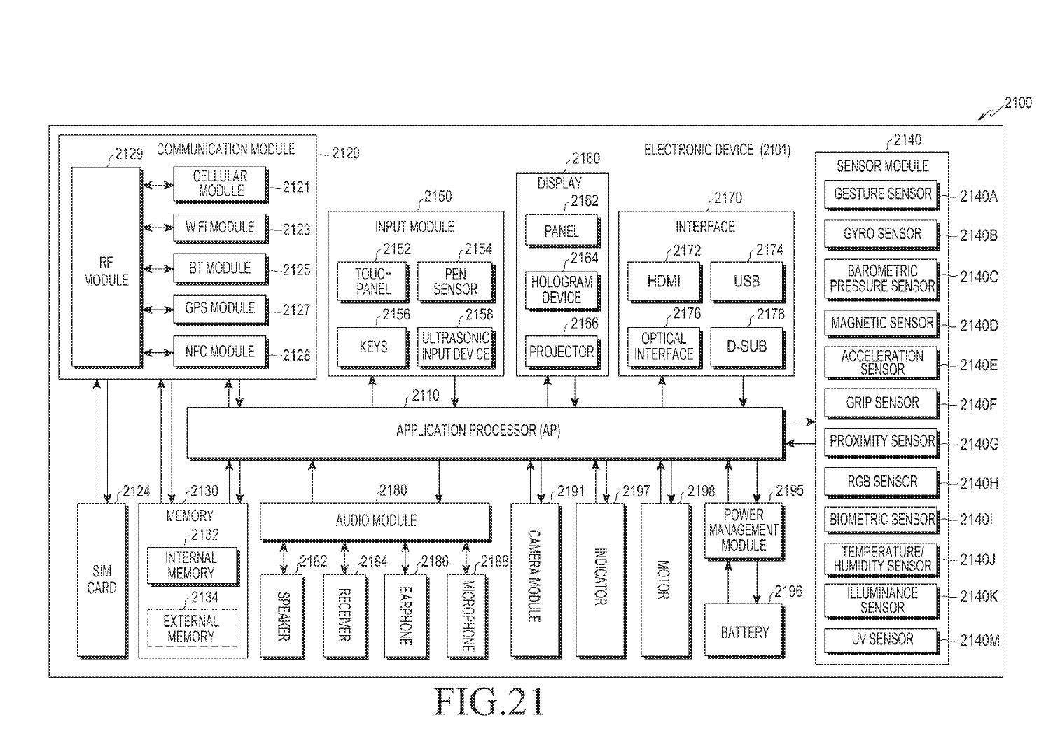

FIG. 21 is a block diagram of an electronic device, according to various embodiments of the present invention.

Referring to FIG. 21, the electronic device 2100 is provided. The electronic device 2100 may include all or part of the components illustrated in FIG. 21.

Referring to FIG. 21, the electronic device 2100 includes at least one Application Processor (AP) 2110, a communication module 2120, a Subscriber Identification Module (SIM) card 2124, a memory 2130, a sensor module 2140, an input module 2150, a display 2160, an interface 2170, an audio module 2180, a camera module 2191, a power management module 2195, a battery 2196, an indicator 2197, and a motor 2198.

The AP 2110 controls multiple hardware or software components connected to the AP 2110 by driving the Operating System (OS) or application programs, and processes and calculates various data including multimedia data The AP 2110 may be implemented as, for example, a System on Chip (SoC). In one embodiment, the AP 2110 may further include a Graphic Processing Unit (GPU).

The communication module 2120 (e.g., the communication interface 160, as shown in FIG. 1) performs data transmission/reception in communication between the electronic device 2100 (e.g., the electronic device 102, as shown in FIG. 1) and other devices (e.g., the electronic device 104 and the server 106, as shown in FIG. 1) connected over the network (e.g. network 162, as shown in FIG. 1). In one embodiment, the communication module 2120 includes a cellular module 2121, a WiFi module 2123, a BT module 2125, a GPS module 2127, an NFC module 2128, and a Radio Frequency (RF) module 2129.

The cellular module 2121 provides voice call services, video call services, text services, an Internet service, or the like, over the communication network (e.g., Long Term Evolution (LTE), Long Term Evolution Advanced (LTE-A), Code Division Multiple Access (CDMA), Wideband Code Division Multiple Access (WCDMA), Universal Multimedia Telecommunications System (UMTS), Wireless Broadband (WiBro), Global System for Mobile communication (GSM), or the like). The cellular module 2121 may, for example, identify and authenticate an electronic device in the communication network using a subscriber identity module (e.g., the SIM card 2124). In one embodiment, the cellular module 2121 performs at least some of the functions that the AP 2110 can provide. For example, the cellular module 2121 may perform at least some of the multimedia control functions.

In one embodiment, the cellular module 2121 includes a Communication Processor (CP). The cellular module 2121 may be implemented as, for example, an SoC. Although the components such as the cellular module 2121 (e.g., the CP), the memory 2130, the power management module 2195, or the like are illustrated as separate components independent of the AP 2110 in FIG. 21, the AP 2110 may be implemented to include at least some (e.g., the cellular module 2121) of the above components in one embodiment.

In one embodiment, the AP 2110 or the cellular module 2121 (e.g., the communication processor) loads, in a volatile memory, the command or data received from a nonvolatile memory or at least one of other components, which is or are connected thereto, and processes the loaded data. The AP 2110 or the cellular module 2121 stores, in a nonvolatile memory, the data that is received from at least one of the other components or generated by at least one of the other components.

Each of the WiFi module 2123, the BT module 2125, the GPS module 2127, and the NFC module 2128 may include, for example, a processor for processing the data that is transmitted or received through the module. Although the cellular module 2121, the WiFi module 2123, the BT module 2125, the GPS module 2127, and the NFC module 2128 are illustrated as separate blocks in FIG. 21, at least some (e.g., two or more) of the cellular module 2121, the WiFi module 2123, the BT module 2125, the GPS module 2127, and the NFC module 2128 may be incorporated into a single Integrated Chip (IC) or IC package in one embodiment. For example, at least some (e.g., a communication processor corresponding to the cellular module 2121 and a WiFi processor corresponding to the WiFi module 2123) of the processors corresponding to the cellular module 2121, the WiFi module 2123, the BT module 2125, the GPS module 2127, and the NFC module 2128 is implemented as one SoC.

The RF module 2129 transmits and receives data or RF signals. The RF module 2129 may include, for example, a transceiver, a Power Amp Module (PAM), a frequency filter, a Low Noise Amplifier (LNA), or the like. The RF module 2129 may further include parts (e.g., a conductor, a conducting wire or the like) for transmitting and receiving radio waves in the free space in wireless communication. Although it is assumed in FIG. 21 that the cellular module 2121, the WiFi module 2123, the BT module 2125, the GPS module 2127, and the NFC module 2128 share one RF module 2129, at least one of the cellular module 2121, the WiFi module 2123, the BT module 2125, the GPS module 2127, and the NFC module 2128 may transmit and receive RF signals through one separate RF module in one embodiment.

The SIM card 2124 is a card including a subscriber identity module, and is inserted into a slot formed in a specific position of the electronic device 2100. The SIM card 2124 includes unique identification information (e.g., Integrated Circuit Card Identifier (ICCID)) or subscriber information (e.g., International Mobile Subscriber Identity (IMSI)).

The memory 2130 (e.g., the memory 130) includes an internal memory 2132 or an external memory 2134. The internal memory 2132 may include at least one of, for example, a volatile memory (e.g., Dynamic RAM (DRAM), Static RAM (SRAM), Synchronous Dynamic RAM (SDRAM), etc.) and a nonvolatile memory (e.g., One Time Programmable ROM (OTPROM), Programmable ROM (PROM), Erasable and Programmable ROM (EPROM), Electrically Erasable and Programmable ROM (EEPROM); mask ROM, flash ROM, NAND flash memory, NOR flash memory, etc.).

In one embodiment, the internal memory 2132 is a Solid State Drive (SSD). The external memory 2134 may further include a flash drive, for example, a Compact Flash (CF) drive, a Secure Digital (SD) card, a Micro Secure Digital (Micro-SD) card, a Mini Secure Digital (Mini-SD) card, an Extreme Digital (xD) card, a memory stick, or the like. The external memory 2134 may be functionally connected to the electronic device 2100 through a variety of interfaces.

In one embodiment, the electronic device 2100 may further include a storage device (or a storage medium) such as a hard drive.

The sensor module 2140 measures physical quantities or detects an operating state of the electronic device 2100, and converts the measured or detected information into an electrical signal. The sensor module 2140 includes at least one of, for example, a gesture sensor 2140A, a gyro sensor 2140B, a barometric pressure sensor 2140C, a magnetic sensor 2140D, an acceleration sensor 2140E, a grip sensor 2140F, a proximity sensor 2140E a color sensor (e.g., Red/Green/Blue (RGB) sensor) 2140H, a biometric sensor 2140I, a temperature/humidity sensor 2140J, an illuminance sensor 2140K, and an Ultra Violet (UV) sensor 2140L. Additionally or alternatively, the sensor module 2140 may include, for example, an electronic nose (E-nose) sensor, an electromyography (EMG) sensor, electroencephalogram (EEG) sensor, electrocardiogram (ECG) sensor, Infra Red (IR), an iris sensor, a fingerprint sensor, or the like. The sensor module 2140 may further include a control circuit for controlling at least one sensor belonging to the sensor module 2140.

The input module 2150 includes a touch panel 2152, a (digital) pen sensor 2154, keys 2156, or an ultrasonic input device 2158.

The touch panel 2152 recognizes at least one of, for example, a capacitive, a resistive, an infrared, and an ultrasonic touch input. The touch panel 2152 may further include a control circuit. The touch panel 2152 recognizes a physical contact or proximity, if the touch panel 2152 is a capacitive touch panel. The touch panel 2152 may further include a tactile layer. In this case, the touch panel 2152 provides tactile feedbacks to the user.

The (digital) pen sensor 2154 is implemented using, for example, a method equal or similar to receiving a user's touch input, or a separate recognition sheet.

The keys 2156 include, for example, a physical button, an optical key, or a keypad.

The ultrasonic input device 2158 is a device that can check data by detecting sound waves with a microphone (MIC) 2188 in the electronic device 2100, using an input tool that generates ultrasonic signals. The ultrasonic input device 2158 may enable wireless recognition. In one embodiment, the electronic device 2100 receives a user input from an external device (e.g., a computer or a server) connected thereto, using the communication module 2120.

The display 2160 (e.g., the display 150) includes a panel 2162, a hologram device 2164, or a projector 2166.

The panel 2162 may be, for example, a Liquid-Crystal Display (LCD) panel, an Active-Matrix Organic Light-Emitting Diode (AM-OLED) panel, or the like. The panel 2162 may be, for example, flexible, transparent, or wearable. The panel 2162, together with the touch panel 2152, may be configured as one module.

The hologram device 2164 displays stereoscopic images in the air using the interference of light.

The projector 2166 displays images by projecting light onto a screen. The screen may be located on, for example, the inside or outside of the electronic device 2100.

In one embodiment, the display 2160 may further include a control circuit for controlling the panel 2162, the hologram device 2164 or the projector 2166.

The interface 2170 includes, for example, an HDMI 2172, a USB 2174, an optical interface 2176, or a D-subminiature (D-sub) 2178. Additionally or alternatively, the interface 2170 may include, for example, a Mobile High-definition Link (MHL) interface, a Secure Digital (SD) card/Multi-Media Card (MMC) interface, or an Infrared Data Association (IrDA) interface.

The audio module 2180 converts sounds and electrical signals bi-directionally. The audio module 2180 process the sound information that is received or output through, for example, a speaker (SPK) 2182, a receiver 2184, an earphone 2186, or a microphone 2188.

The camera module 2191, which is a device capable of shooting or capturing still images and videos, may include one or more image sensors (e.g., front sensor or rear sensor), a lens, an Image Signal Processor (ISP), or a flash (e.g., Light-Emitting Diode (LED) or xenon lamp) in one embodiment.

The power management module 2195 manages the power of the electronic device 2100. The power management module 2195 may include, for example, a Power Management Integrated Circuit (PMIC), a charger Integrated Circuit (IC), or a battery or fuel gauge.

The PMIC may be mounted in, for example, an integrated circuit or an SoC chip.

A charging scheme may be classified into a wired charging scheme and a wireless charging scheme. The charger IC charges a battery, and prevents an inflow of overvoltage or overcurrent from the charger. In one embodiment, the charger IC may include a charger IC for at least one of the wired charging scheme and the wireless charging scheme. The wireless charging scheme may include, for example, a magnetic resonance scheme, a magnetic induction scheme, an electromagnetic wave scheme, or the like, and the charger IC may further include an additional circuit for wireless charging (e.g., a loop coil, a resonance circuit, a rectifier, or the like).

The battery gauge measures, for example, the remaining capacity, the charging voltage and current, or the temperature of the battery 2196.

The battery 2196 stores or generates electricity, and supplies power to the electronic device 2100 using the stored or generated electricity. The battery 2196 may include, for example, a rechargeable battery or a solar battery.

The indicator 2197 indicates specific states (e.g., a boot state, a message state, a charging state, or the like) of the electronic device 2100 or a part (e.g., the AP 2110) thereof.

The motor 2198 converts an electrical signal into mechanical vibrations.

The electronic device 2100 may further include a processing unit (e.g., GPU) for support of a mobile TV. The processing unit for support of a mobile TV processes the media data that is based on, for example, Digital Multimedia Broadcasting (DMB), Digital Video Broadcasting (DVB), Media Flow, or the like.

Each of the above-described components of the electronic device 2100, according to various embodiments of the present invention, may be configured as one or more components, and the name of the component may vary depending on the type of the electronic device. The electronic device 2100 according to various embodiments of the present invention, may be configured to include at least one of the above-described components, and the electronic device 2100 may exclude some of the components, or may further include additional other components. Some of the components of the electronic device 2100, according to various embodiments of the present invention, may be configured as one entity by being combined, thereby making it possible to perform, in the same way, the functions of the components, which were performed before the components were combined.

The term ‘module’, as used in various embodiments of the present invention, refers to a unit that includes any one or a combination of, for example, hardware, software and firmware. The term ‘module’ is interchangeably used with a term such as, for example, ‘unit’, ‘logic’, ‘logical block’, ‘component’ or ‘circuit’. The ‘module’ is the minimum unit of an integrated component, or a part thereof. The ‘module’ is the minimum unit of performing one or more functions, or a part thereof. The ‘module’ is implemented mechanically or electronically. For example, the ‘module’, according to various embodiments of the present invention, includes at least one of an Application-Specific Integrated Circuit (ASIC) chip, Field-Programmable Gate Arrays (FPGAs), and a programmable-logic device, each of which performs any operations that are known or to be developed in the future.

In accordance with various embodiments, at least a part of the device (e.g., modules or functions thereof) or method (e.g., operations) according to various embodiments of the present invention may be implemented by, for example, instructions that are stored in a computer-readable storage media in the form of a programming module. If an instruction is executed by one or more processors, the one or more processors may perform the function corresponding to the instruction. The computer-readable storage media may be, for example, a memory. At least a part of the programming module may be implemented (e.g., executed) by, for example, the processor. At least a part of the programming module may include, for example, a module, a program, a routine, a set of instructions, or a process for performing one or more functions.

The computer-readable storage media may include magnetic media (e.g., hard disk, floppy disk, magnetic tape, etc.), optical media (e.g., Compact Disc Read Only Memory (CD-ROM), Digital Versatile Disc (DVD), etc.), magneto-optical media (e.g., floptical disk, etc.), and a hardware device (e.g., Read Only Memory (ROM), Random Access Memory (RAM), flash memory, etc.) that is specially configured to store and execute a program instruction (e.g., a programming module). The program instruction may include, not only the machine code created by the compiler, but also a high-level language code that can be executed by the computer using an interpreter or the like. The hardware device may be configured to operate as one or more software modules to perform the operations in various embodiments of the present invention, and vice versa.

It can be appreciated that embodiments of the present invention may be implemented by hardware, software, or a combination thereof. The software may be stored in a nonvolatile storage (e.g., an erasable/re-writable ROM, etc.), a memory (e.g., RAM, memory chip, memory device, memory IC, etc.), or an optically or magnetically recordable machine (e.g., computer)-readable storage medium (e.g., CD, DVD, magnetic disk, magnetic tape, etc.). A memory that can be mounted in an electronic device is an example of the machine-readable storage medium suitable to store a program or programs including instructions for implementing embodiments of the present invention. Therefore, the present invention may include a program including codes for implementing the apparatus or method defined by the appended claims, and a machine-readable storage medium storing the program. The program may be electronically carried by any media or its equivalents such as communication signals which are transmitted through wired or wireless connections.

As is apparent from the foregoing description, according to various embodiments of the present invention, an electronic device is implemented to split its screen into a first screen and a second screen, contributing to an increase in the usability of the electronic pen in the conventional electronic device which is mainly controlled by the fingers. Accordingly, it is possible to provide a utilization method for enabling the electronic device and the user to interact with each other in a variety of ways.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A method for displaying a screen in an electronic device, the method comprising:
displaying, in a split way, a first screen for displaying information corresponding to one or more objects and a second screen for displaying the objects to assist the first screen;
detecting a pen interaction on the second screen;
identifying an object in a position corresponding to the pen interaction; and
displaying information corresponding to the identified object and the pen interaction on the first screen.

2. The method of claim 1, wherein displaying the information corresponding to the identified object and the pen interaction on the first screen comprises:
when the pen interaction is to display a preview screen for an object, displaying the preview screen for the identified object on the first screen.

3. The method of claim 2, further comprising:
when a pen interaction to select the preview screen is detected, executing the identified object and displaying the executing identified object on the first screen in a form of a pop-up window.

4. The method of claim 2, further comprising:
when a pen interaction to select a display exit button for the preview screen is detected, or when a pen interaction to select the preview screen is not detected within a specified period of time,
exiting the display of the preview screen.

5. The method of claim 1, wherein displaying the information corresponding to the identified object and the pen interaction on the first screen comprises:
when the pen interaction is to display an execution screen for an object on the first screen, executing the identified object and displaying the execution screen for the executing identified object on the first screen.

6. The method of claim 5, further comprising:
displaying an image on the identified object, indicating a selection of the identified object; and
when a pen interaction to deselect the identified object is detected,
exiting the display of the image on the identified object, and
exiting the display of the execution screen.

7. The method of claim 1, further comprising:
when the pen interaction is detected on the second screen, determining whether a pen used for the pen interaction is an approved pen for use in the electronic device; and
when the pen used for the pen interaction is not the approved pen,
preventing identifying the object in the position corresponding to the pen interaction, and
preventing displaying the information corresponding to the identified object and the pen interaction on the first screen.

8. The method of claim 7, further comprising:
when the pen used for the pen interaction is not the approved pen, displaying, on the first screen, a warning message screen indicating that the pen used for the pen interaction is not the approved pen.

9. The method of claim 1, wherein displaying the information corresponding to the identified object and the pen interaction on the first screen comprises:
when the pen interaction is to display a preview screen for applying a function of an object to the first screen or to content of the first screen, displaying the preview screen having the function of the identified object applied to the first screen or to the content of the first screen.

10. The method of claim 1, wherein displaying the information corresponding to the identified object and the pen interaction on the first screen comprises:
when the pen interaction is to apply a function of an object to the first screen or to content of the first screen, applying the function of the identified object to the first screen or to the content of the first screen.

11. The method of claim 1, further comprising:
when the pen interaction to select information displayed on the first screen is detected, displaying at least one piece of information corresponding to the selected information, on the second screen.

12. The method of claim 1, wherein the object in the position corresponding to the pen interaction includes at least one of an icon, a widget, a notification indicator, indicating an event that has occurred in the electronic device, schedule information, content, an edit item for editing of the first screen, an edit item for editing content displayed on the first screen, and metadata information of the content displayed on the first screen.

13. The method of claim 1, wherein the first screen and the second screen are non-coplanar.

14. An electronic device comprising:
a touch screen; and
a processor configured to display, in a split way, a first screen for displaying information corresponding to one or more objects and a second screen for displaying the objects to assist the first screen, detect a pen interaction on the second screen, identify an object in a position corresponding to the pen interaction, and display information corresponding to the identified object and the pen interaction on the first screen.

15. The electronic device of claim 14, wherein when the pen interaction is to display a preview screen for an object, the processor is configured to display the preview screen for the identified object on the first screen, and
when the pen interaction is to display an execution screen for an object on the first screen, the processor is configured to execute the identified object and display the execution screen for the executing object on the first screen.

16. The electronic device of claim 14, wherein when the pen interaction is to display a preview screen for applying a function of an object to the first screen or to content of the first screen, the processor is configured to display the preview screen having the function of the identified object applied to the first screen or to the content of the first screen, and
when the pen interaction is to apply a function of an object to the first screen or to the content of the first screen, the processor is configured to apply the function of the identified object to the first screen or to the content of the first screen.

17. The electronic device of claim 14, wherein the first screen and the second screen are non-coplanar.
